(19) United States
(12) Patent Application Publication
(10) Pub. No.: US 2024/0264280 A1
(43) Pub. Date: Aug. 8, 2024

(54) LIDAR INTEGRATED VEHICLE LIGHTS

(71) Applicant: Innovusion, Inc., Sunnyvale, CA (US)

(72) Inventors: Yimin Li, Cupertino, CA (US); Chen Gu, San Jose, CA (US); Junwei Bao, Los Altos, CA (US)

(73) Assignee: Innovusion, Inc., Sunnyvale, CA (US)

(21) Appl. No.: 18/387,818

(22) Filed: Nov. 7, 2023

Related U.S. Application Data
(60) Provisional application No. 63/443,347, filed on Feb. 3, 2023.

(51) Int. Cl. G01S 7/481; B60Q 1/00; G01S 17/931

(52) U.S. Cl. CPC G01S 7/4816; B60Q 1/0023; G01S 17/931

(57) ABSTRACT

A system for light ranging and detection (LiDAR) integrated with vehicle light fixtures is provided. The system includes one or more light sources configured to generate transmission light; a window; and a steering mechanism. The steering mechanism is controlled to: steer a detection portion of the transmission light toward a field-of-view (FOV) of the LiDAR via the window, and receive return light formed based on the detection portion of the transmission light in the FOV. A non-detection portion of the transmission light is transmitted in a visible light spectrum to a field-of-illumination (FOI) via the window.

### CROSS-REFERENCE TO RELATED APPLICATIONS

This application claims priority to U.S. Provisional Patent Application Ser. No. 63/443,347, filed Feb. 3, 2023, entitled “LIDAR INTEGRATED VEHICLE LIGHTS,” the content of which is hereby incorporated by reference in its entirety for all purposes.

### FIELD OF THE TECHNOLOGY

This disclosure relates generally to a light detection and ranging (LiDAR) system and, more particularly, to integrated LiDAR and vehicle light systems.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminate an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

Most vehicles have vehicle lights mounted in casings or fixtures to provide vehicle driving light signals, safety light signals, or illumination of driving environment. Additional fixtures for vehicle mounted LiDAR systems may require additional space in or on the vehicle, and additional LiDAR fixtures may degrade the aesthetic appearances and/or aerodynamic performance of the vehicle. Therefore, there is a need to integrate one or more LiDAR systems with vehicle light fixtures. The vehicle light fixture integrated with a LiDAR system can thus provide both vehicle light functions (e.g., illumination and signaling) and LiDAR detection, while maintaining a compact size without impacting, or with minimum impact of, the vehicle's performance and appearance.

According to an embodiment, a system for light ranging and detection (LiDAR) integrated with vehicle light fixtures includes one or more light sources configured to generate transmission light; an aperture window; and a steering mechanism. The steering mechanism is controlled to: steer a detection portion of the transmission light toward a field-of-view (FOV) of the LiDAR via the aperture window, and receive return light formed based on the detection portion of the transmission light in the FOV. A non-detection portion of the transmission light is transmitted in a visible light spectrum to a field-of-illumination (FOI) via the aperture window.

A method for operating an integrated light ranging and detection (LiDAR) and vehicle light system is provided. The system is mountable to a vehicle. The method comprises generating transmission light by one or more light sources; and controlling a steering mechanism to: steer a detection portion of the transmission light toward a field-of-view (FOV) of the LiDAR via an aperture window, and receive return light formed based on the detection portion of the transmission light in the FOV. The method further comprises transmitting a non-detection portion of the transmission light in a visible light spectrum to a field-of-illumination (FOI) via the aperture window.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example fiber-based laser source.

FIGS. 5A-5C illustrate an example LiDAR system using pulse signals to measure distances to objects disposed in a field-of-view (FOV).

FIG. 6 is a block diagram illustrating an example apparatus used to implement systems, apparatus, and methods in various embodiments.

FIG. 7A is a block diagram illustrating an example integrated LiDAR and vehicle light system, according to some embodiments.

FIG. 7B illustrates an example LiDAR system integrated with illumination light fixtures, according to some embodiments.

FIG. 7C illustrates an example LiDAR system integrated with signaling light fixtures, according to some embodiments.

FIG. 8A-8E are block diagrams illustrating example integrated LiDAR and vehicle light systems, according to some embodiments.

FIG. 9A is a block diagram illustrating an aperture window configured to perform wavelength conversion, according to some embodiments.

FIG. 9B is a block diagram illustrating an optical wavelength converter configured to perform wavelength conversion, according to some embodiments.

FIG. 10A is a block diagram illustrating example light emitting elements and an aperture window including an optical diffuser for forming a light pattern using the non-detection portion of the transmission light, according to some embodiments.

FIG. 10B is a block diagram illustrating example light emitting elements and a back-illumination micro-lenses array for forming a light pattern using the non-detection portion of the transmission light, according to some embodiments.

FIGS. 10C-10D are block diagrams illustrating example light emitting elements, light patterning optics, and optical modulators for forming a light patten using the non-detection portion of the transmission light, according to some embodiments.

FIG. 11 is a diagram illustrating an integrated LiDAR and vehicle light system operative to detect a human being and adjust illumination on or near the human being according to some embodiments.

FIG. 12 is a diagram illustrating an example integrated LiDAR and vehicle light system projecting light patterns near a vehicle to which the integrated LiDAR and vehicle light system is mounted, according to some embodiments.

FIG. 13 is a diagram illustrating an example integrated LiDAR and vehicle light system projecting light patterns near a target vehicle, according to some embodiments.

FIG. 14 is a diagram illustrating an example integrated LiDAR and vehicle light system projecting light patterns near a pedestrian, according to some embodiments.

FIG. 15 is a diagram illustrating an example integrated LiDAR and vehicle light system projecting light patterns onto a roadside object, according to some embodiments.

FIGS. 16A-16D is a flowchart illustrating a method for operating an example integrated LiDAR and vehicle light system, according to some embodiments.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first light source could be termed a second light source and, similarly, a second light source could be termed a first light source, without departing from the scope of the various described examples. The first light source and the second light source can both be light sources and, in some cases, can be separate and different light sources.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

Most vehicles have vehicle lights mounted in casings or fixtures to provide vehicle driving light signals, safety light signals, or illumination of driving environment. Additional fixtures for vehicle mounted LiDAR systems may require additional space in or on the vehicle, and additional LiDAR fixtures may degrade the aesthetic appearances and/or aerodynamic performance of the vehicle. Therefore, there is a need to integrate one or more LiDAR systems with vehicle light fixtures. The vehicle light fixture integrated with a LiDAR system can thus provide both vehicle light functions (e.g., illumination and/or signaling) and LiDAR detection, while maintaining a compact size without impacting, or with minimum impact of, the vehicle's performance and appearance.

According to an embodiment, a system for light ranging and detection (LiDAR) integrated with vehicle light fixtures includes one or more light sources configured to generate transmission light; an aperture window; and a steering mechanism. The steering mechanism is controlled to: steer a detection portion of the transmission light toward a field-of-view (FOV) of the LiDAR via the aperture window, and receive return light formed based on the detection portion of the transmission light in the FOV. A non-detection portion of the transmission light is transmitted in a visible light spectrum to a field-of-illumination (FOI) via the aperture window.

A method for operating an integrated light ranging and detection (LiDAR) and vehicle light system is provided. The system is mountable to a vehicle. The method comprises generating transmission light by one or more light sources; and controlling a steering mechanism to: steer a detection portion of the transmission light toward a field-of-view (FOV) of the LiDAR via an aperture window, and receive return light formed based on the detection portion of the transmission light in the FOV. The method further comprises transmitting a non-detection portion of the transmission light in a visible light spectrum to a field-of-illumination (FOI) via the aperture window.

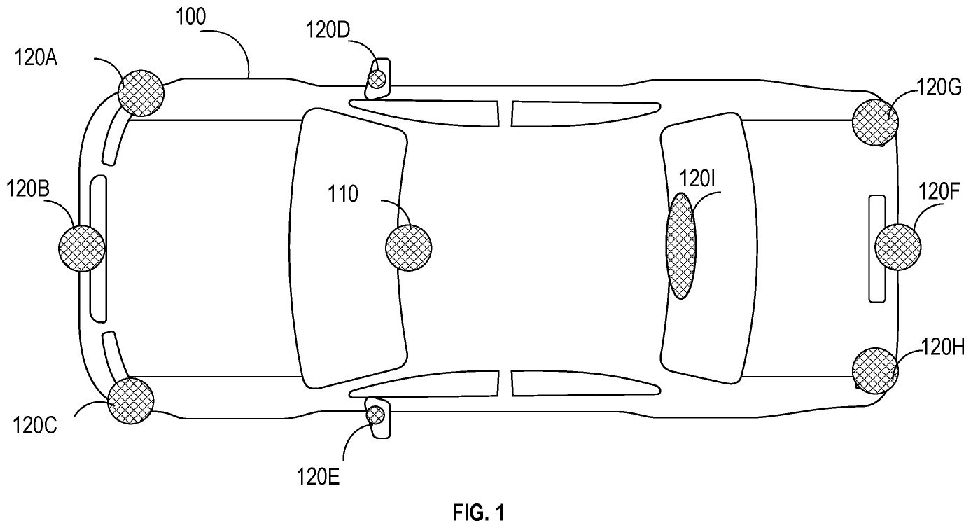

FIG. 1 illustrates one or more example LiDAR systems 110 and 120A-120I disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, an unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but has no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

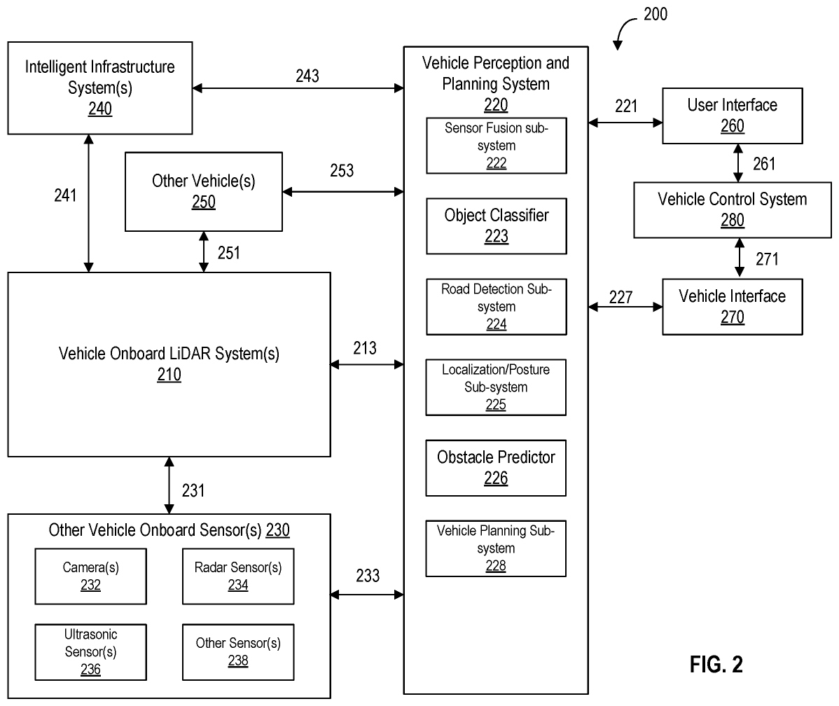

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitate producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mounted on, or integrated to, a vehicle at any location (e.g., rear-view mirrors, pillars, front grille, and/or back bumpers, etc.).

Other vehicle onboard sensos(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located near the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mounted on, or integrated to, a vehicle at any location (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure objects located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any location (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 227 and 271, which include any wired or wireless communication links that can transfer data.

Vehicle control system 280 controls the vehicle's steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

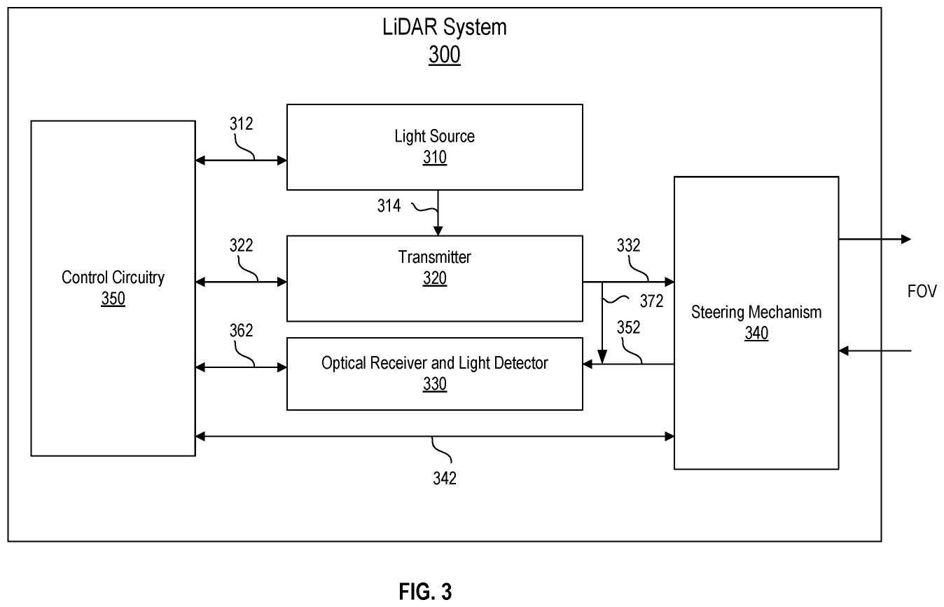

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. Route 372 may include one or more optics (e.g., optical fibers, lens, mirrors, etc.) for providing the light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object's range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

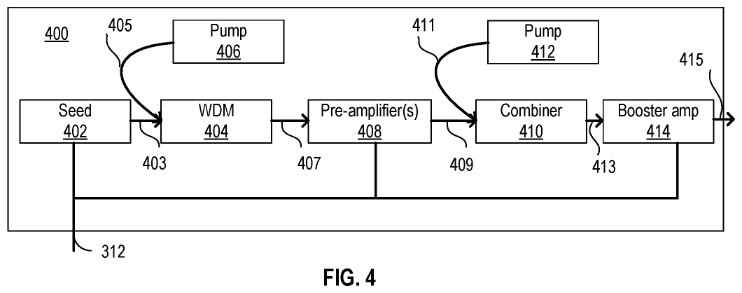

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 415. The booster amplifier 414 provides further amplification of the optical signals (e.g., another 20-40 dB). The output light pulses can then be transmitted to transmitter 320 and/or steering mechanism 340 (shown in FIG. 3). It is understood that FIG. 4 illustrates one example configuration of fiber-based laser source 400. Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structures can be used for a light detector. For example, a light detector structure can be a PIN based structure, which has an undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and/or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, buses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

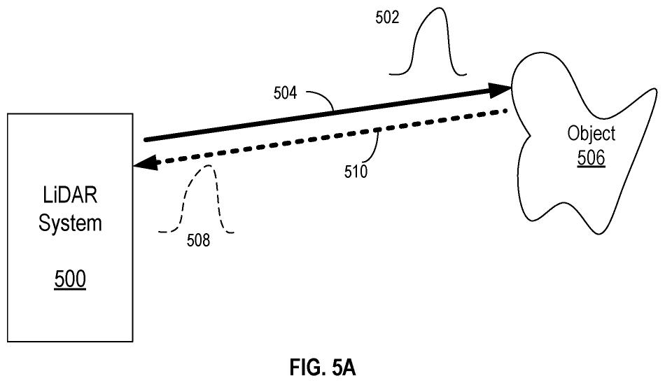

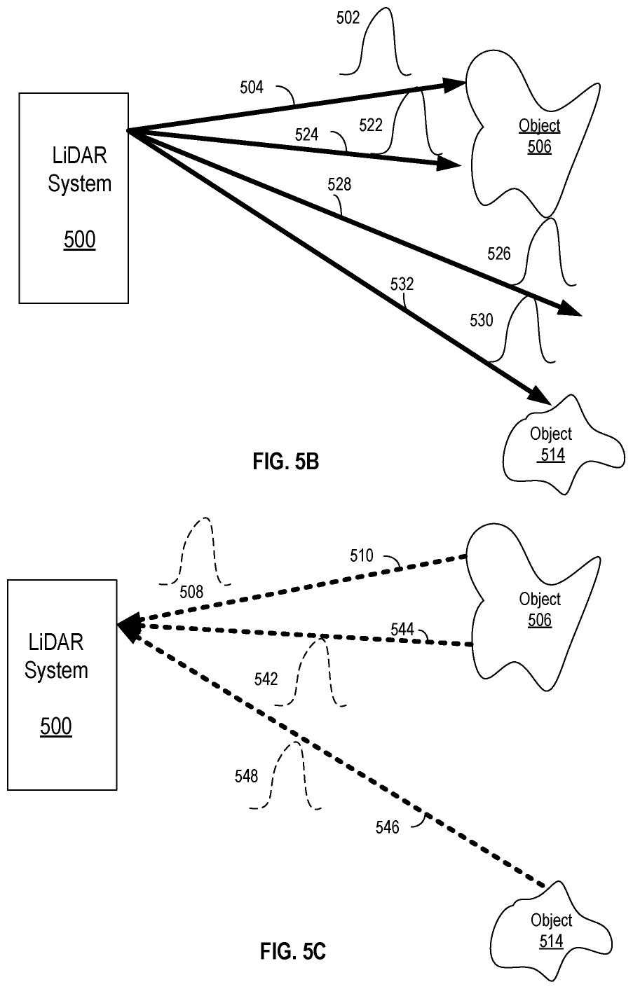

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of at least some of the FIGS. 1-16, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

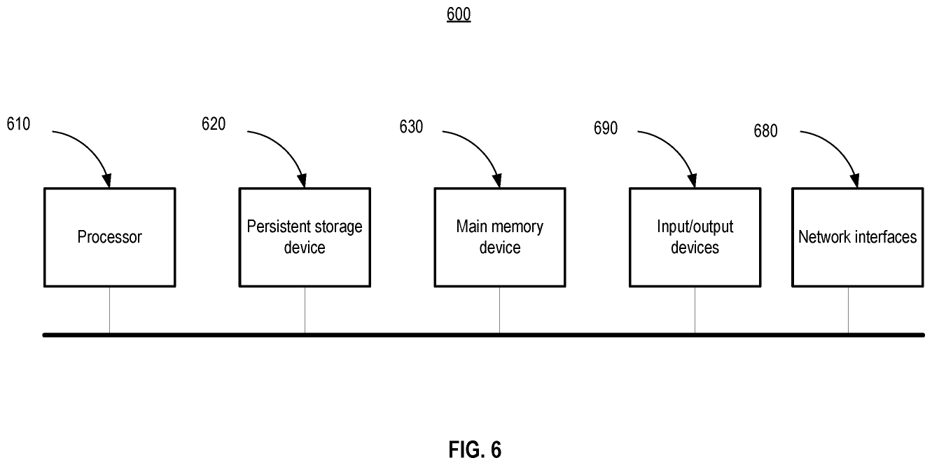

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of at least some of FIGS. 1-16 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein in connection with at least some of FIGS. 1-16. Accordingly, by executing the computer program instructions, the processor 610 executes an algorithm defined by the method steps of these aforementioned figures. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

As described above, most vehicles have vehicle lights mounted in casings or fixtures to provide vehicle driving signals, safety lights, or illumination of driving environment, additional fixtures for vehicle mounted LiDAR systems would take up additional space in or on the vehicles, and additional LiDAR fixtures might degrade the aesthetic appearances of the vehicles. Therefore, there is a need to integrate LiDAR systems with vehicle light fixtures.

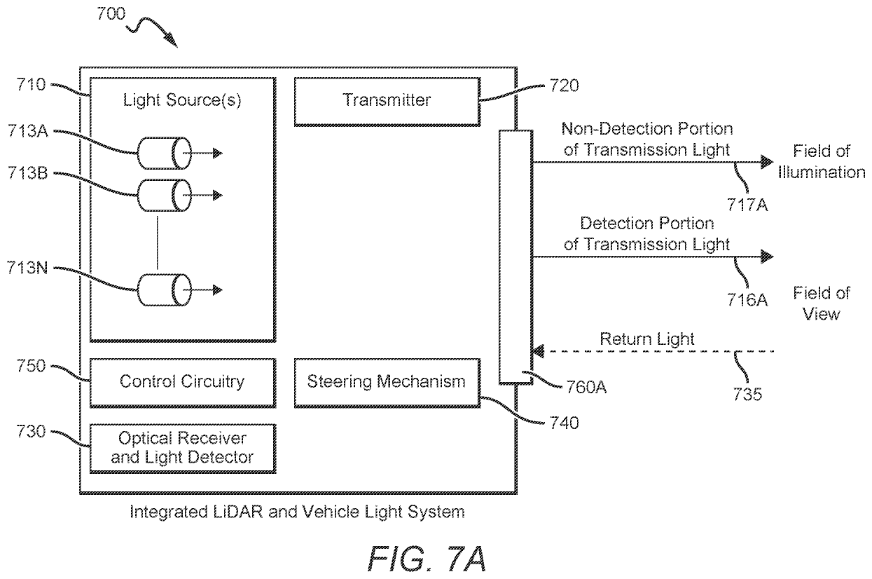

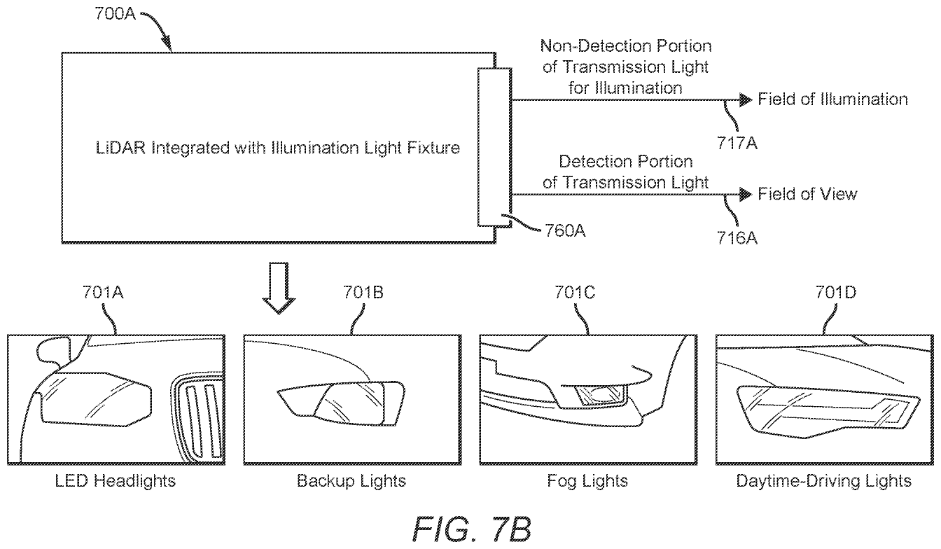

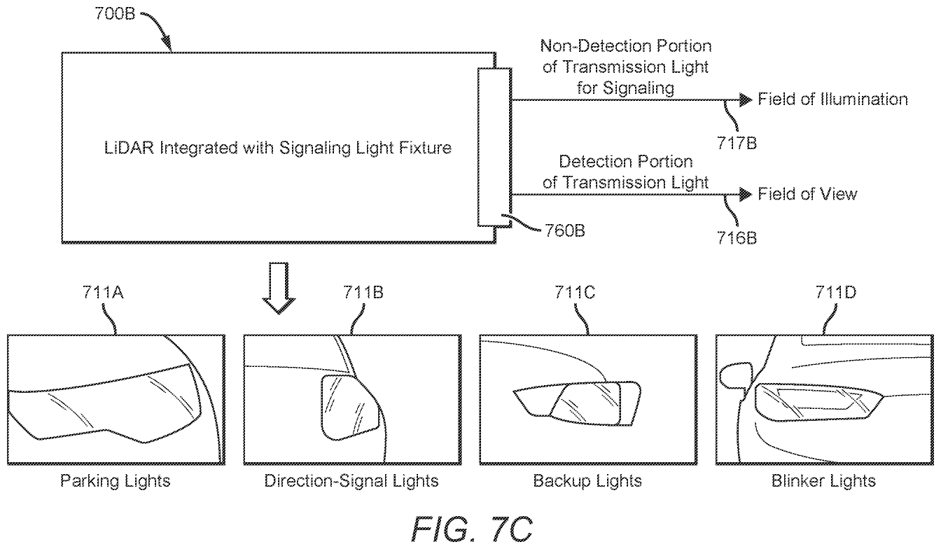

FIG. 7A is a block diagram illustrating an example integrated LiDAR and vehicle light system 700, according to some embodiments. In some examples, system 700 integrates one or more LiDAR components and vehicle light fixtures to form an integrated LiDAR and vehicle light system such that the system may be enclosed in a housing or an assembly. For instance, one or more components in a LiDAR system such as a light source, a transmitter, control circuitry, a steering mechanism, and an optical receiver and light detector can be combined or integrated with existing light fixtures mounted to a vehicle. Such light fixtures may include, but not limited to, fixtures for head lights (e.g., LED (light emitting diode) headlights, HID (high-intensity discharge) headlights, Halogen headlights, etc.), parking lights, direction-signal lights, backup lights, blinker lights, taillights, brake lights, fog lights, day-time-driving lights, and/or hazard lights. An integrated LiDAR and vehicle light system may also be referred to as a LiDAR system integrated with vehicle light, or an integrated system for simplicity.

As shown in FIG. 7A, integrated LiDAR and vehicle light system 700 comprises one or more light sources 710, transmitter 720, control circuitry 750, steering mechanism 740, and optical receiver and light detector 730. One or more light sources 710 may include a first light source configured to generate laser light for the LiDAR system to detect objects in an FOV. This first light source can be substantially the same or similar to light source 310 described above. For instance, the first light source may include a semiconductor-based laser source (e.g., VCSEL), a fiber-based laser source (e.g., a rare-earth doped fiber for emitting laser light), a liquid-based laser source (e.g., dye lasers such as sodium fluorescein, rhodamine B and rhodamine 6G), a solid-state based laser source (e.g., lasers using neodymium crystals, usually doped with either yttrium aluminum garnet (Nd:YAG), yttrium orthovanadate (Nd:YVO₄), or yttrium lithium fluoride (Nd:YLF)), and/or a gas based laser source (e.g., carbon dioxide or CO₂, argon, or helium-neon based lasers). In one example, the first light source emits laser light in the infrared (IR) light spectrum, including one or more of: near-infrared (NIR) light (e.g., wavelengths from 700 nm to 2.5 μm), mid-infrared (MIR) light (e.g., wavelengths from 2.5 μm to 25 μm), far-infrared (FIR) light (e.g., wavelengths from 25 μm to 1 mm). As described in more detail below, the first light source may be used for generating the detection portion of the transmission light 716 for LiDAR detection.

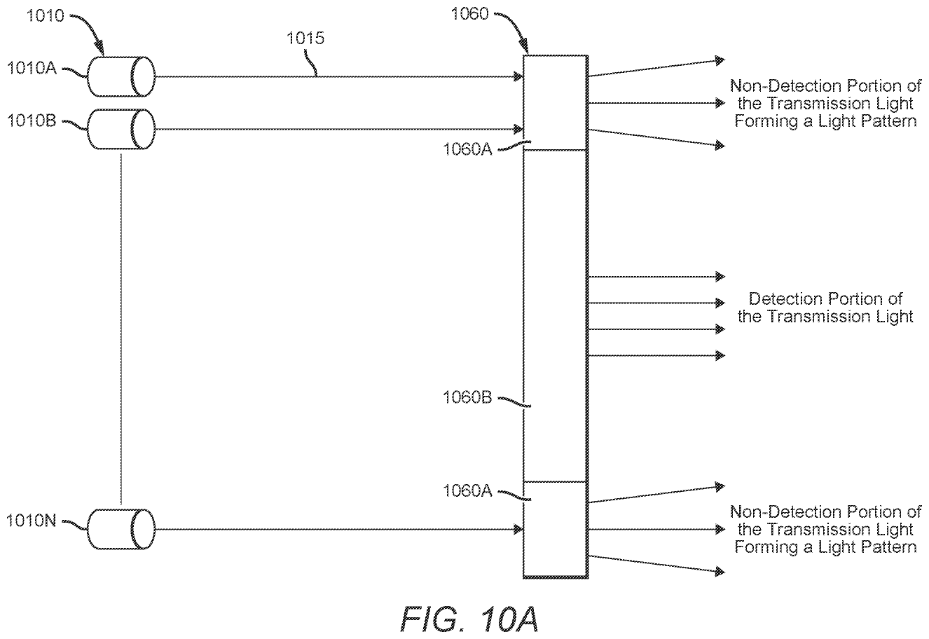

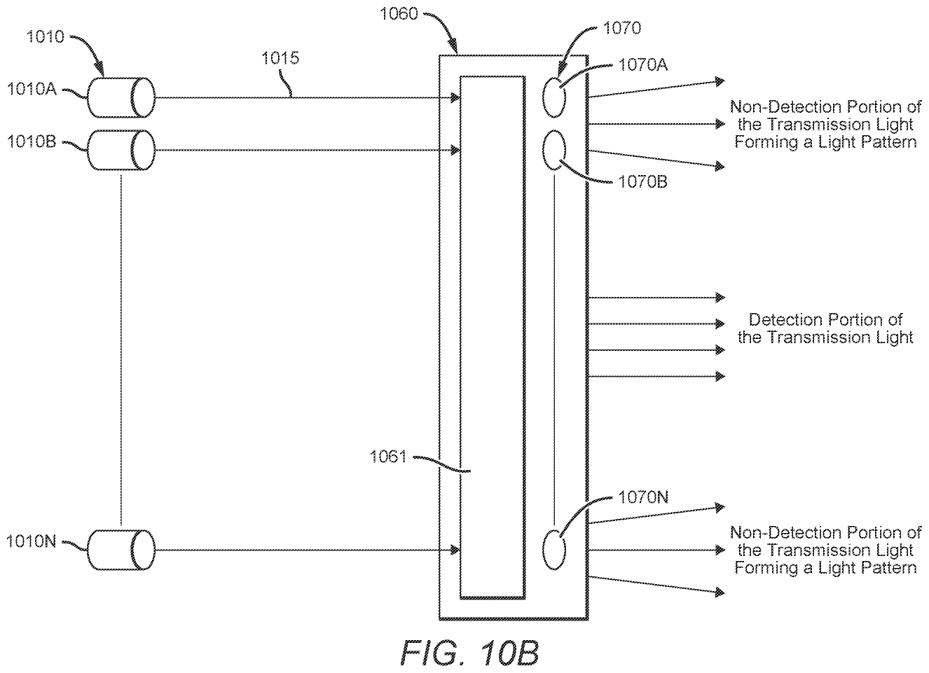

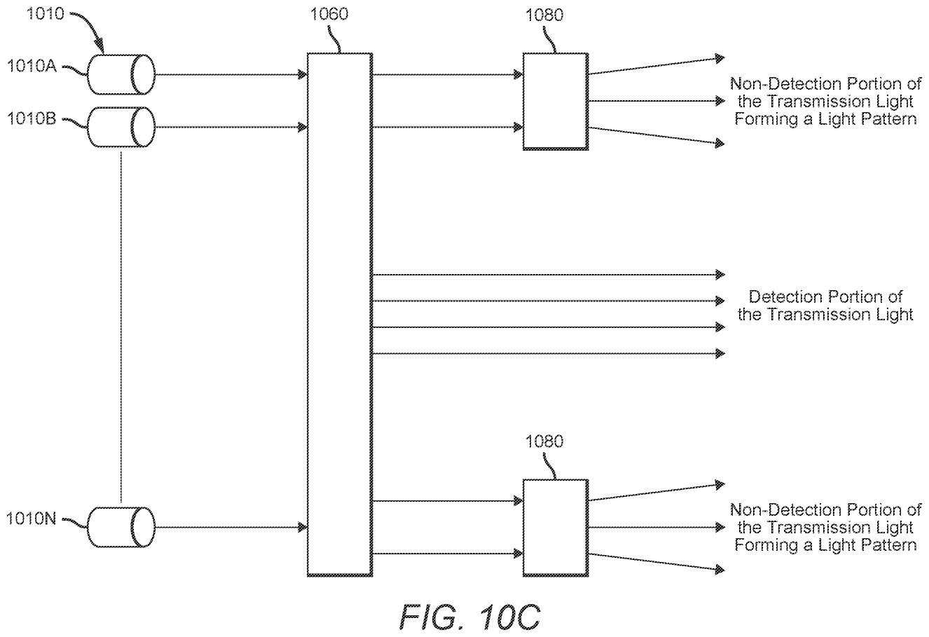

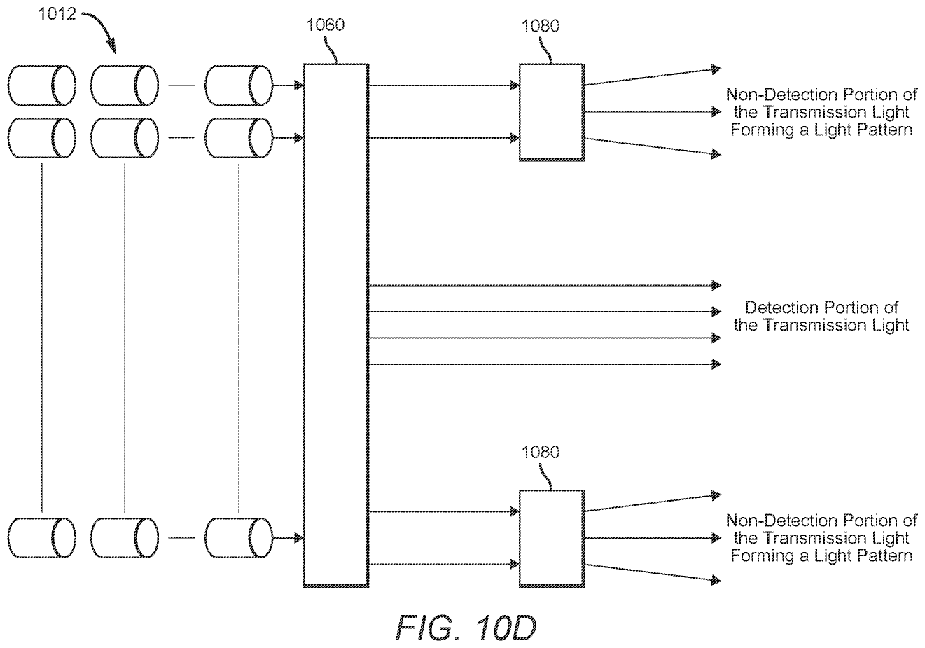

In some embodiments, light sources 710 of integrated LiDAR and vehicle light system 700 may also include a second light source configured to generate light for vehicle illumination and/or signaling. The second light source may thus generate light in the visible light spectrum including light having wavelengths in the range of approximately 400 nm to 700 nm. The second light source may thus include, but not limited to, light-emitting diodes (LEDs), incandescence light sources (e.g., tungsten filament light bulbs), fluorescent light sources, laser diodes, organic LEDs, etc. FIG. 7A illustrates an array of light emitting elements 713A-713N (e.g., RGB LEDs) included in light sources 710. These light emitting elements 713A-713N can be used for generating the non-detection portion of the transmission light, and are described in more detail in FIGS. 10A-10B. In some examples, the second light source may also be configured to generate light in the ultraviolet (UV) light spectrum. For instance, the second light source may include UV fluorescent lamps, low-pressure and medium pressure UV lamps, gas discharge lamps (e.g., mercury vapor lamps), high-intensity discharge lamps (e.g., xenon arc lamps), UV-LEDs, solid-state lasers, etc.

In the above example, light source(s) 710 combine the first light source and the second light source. The first light source is configured to provide detection portion of the transmission light 716 for LiDAR detection; and the second light source is configured to provide non-detection portion of the transmission light 717 for vehicle illumination and/or signaling. Each of the first light source and the second light source can be independently controlled or controlled in a synchronized manner by, for example, control circuitry 750. For instance, if the LiDAR function of system 700 is not used (e.g., if the vehicle is parked or idle), the first light source can be turned off such that there is no detection portion of the transmission light 716. Similarly, if vehicle lights are not used (e.g., when the vehicle operates during daytime and no signaling is required), the second light source can be turned off such that there is no non-detection portion of the transmission light 717. In another example, the first light source and second light source in light source(s) 710 can be turned on simultaneously for generating both the detection portion of the transmission light 716 for LiDAR detection and the non-detection portion of the transmission light 717 for vehicle illumination and/or signaling. They can also be both turned off in certain situations.

In some embodiments, light source(s) 710 includes one light source generating light in one wavelength or wavelength range. For instance, the light source may generate only IR light or only visible light, but not both. Thus, the light source may generate only the detection-portion of the transmission light 716 or only the non-detection portion of the transmission light 717, but not both. A portion of the light generated by such a light source may subsequently be converted to generate light in another wavelength or wavelength range. As described in more detail below, an aperture window and/or another optical component (e.g., an optical wavelength converter) can be used to convert a portion of the light generated by light source 710 to light having another wavelength or wavelength range. Thus, a portion of the light generated by the light source 710 can be converted to either the detection-portion of the transmission light 716 or the non-detection portion of the transmission light 717, depending on the wavelength of the light provided by light source 710. Accordingly, a single light source may be used for providing both the detection portion and the non-detection portion of the transmission light.

With reference still to FIG. 7A, system 700 may include a transmitter 720, which may be substantially the same or similar to transmitter 320 described above in FIG. 3. For instance, transmitter 720 may include one or more optics for receiving light from light source(s) 710 and redirecting them to steering mechanism 740, the FOV of the integrated LiDAR and vehicle light system, and/or the FOI of the integrated system. Transmitter 720 may include one or more optics such as optical lenses, mirrors, prisms, optical fibers, micro lenses, diffusers, optical waveguides, optical retroreflectors, etc. In one example, transmitter 720 includes an optical fiber array having a plurality of optical fibers spaced apart from each other at a predetermined pitch. The optical fiber array forms multiple transmitter channels for providing multiple transmission light beams. The multiple transmission light beams can be used to form the detection portion of the transmission light 716 and/or the non-detection portion of the transmission light 717.

In FIG. 7A, steering mechanism 740 can be substantially the same or similar to steering mechanism 340 described above in FIG. 3. For example, steering mechanism 740 may include one or more of: a polygon mirror, a planar mirror, a microelectromechanical systems (MEMS) mirror, an optical prism, and an optical lens. Some of the examples in this disclosure use a combination of a polygon mirror and a planar mirror as an example for steering mechanism 740. Steering mechanism 740 can steer the detection portion of the transmission light 716 toward a field-of-view (FOV) of the integrated system 700 for LiDAR detection, and/or steer the non-detection portion of the transmission light 717 toward a field-of-illumination (FOI) of the integrated system 700 for illumination and/or signaling. For the detection portion of the transmission light 716, steering mechanism 740 can steer the light 716 in one or two directions (e.g., horizontal and vertical directions). The horizontal direction generally is the direction parallel to the road surface on which a vehicle having an integrated LiDAR and vehicle light system operates. The vertical direction generally is the direction perpendicular to the horizontal direction. The detection portion of the transmission light 716 is scanned in both the horizontal direction and the vertical direction to facilitate LiDAR detection of objects in the FOV of system 700. In some embodiments, steering mechanism 740 may also scan the non-detection portion of transmission light 717 in the horizontal and/or vertical direction. The scanned non-detection portion of transmission light 717 may form a light pattern for illumination of the surrounding environment and/or for vehicle signaling. The area in the surrounding environment that is scannable or covered by the non-detection portion of transmission light 717 is also referred to as the field-of-illumination (FOI), regardless of whether the non-detection portion of transmission light 717 is used for illumination or for vehicle signaling.

In certain embodiments, steering mechanism 740 only steers the detection portion of transmission light 716 but not the non-detection portion of transmission light 717. The light source(s) 710 and/or the transmitter 720 may directly transmit the non-detection portion of transmission light 717 toward the FOI of the integrated system 700 via aperture window 760. Regardless of whether steering mechanism 740 scans the non-detection portion of transmission light 717, the detection portion of transmission light 716 may be scanned in the FOV to detect one or more objects. The detection portion of transmission light 716 is scattered or reflected by objects in the FOV to form return light 735. Return light 735 is received by integrated system 700. In one embodiment, return light 735 is received by steering system 740, which redirects the return light 735 to optical receiver and light detector 730. Optical receiver and light detector 730 can be substantially the same or similar to optical receiver and light detector 330 described above. For instance, it may include a collection lens, a filter, a slit, a lens group, and/or other receiving optics for collecting, filtering, and redirecting the return light 735 directed by steering mechanism 740 (or directly from the FOV). The return light 735 may then be focused on one or more light detectors (or arrays of light detectors) for converting the optical signals to electrical signals. The electrical signals can then be further processed (e.g., by control circuitry 750) to generate a 3D point cloud representing the objects in the FOV. Control circuitry 750 can be substantially the same of similar to control circuitry 350 described above. For instance, in addition to processing the signals representing return light 735, control circuitry 350 may also communicate with light source(s) 710, transmitter 720, steering mechanism 740, and/or optical receiver and light detector 730 for controlling the operation of these components and for receiving feedback signals from these components.

As illustrated in FIG. 7A, one or both of the detection portion of transmission light 716 and the non-detection portion of transmission light 717 are directed toward external of system 700 via aperture window 760. Aperture window 760 can include one or more optics that are transparent to both the detection portion of transmission light 716 and the non-detection portion of transmission light 717. For instance, it may be transparent for both IR light and visible light. As described below in more detail, it may also include optics for converting light in one wavelength or wavelength range to another wavelength or wavelength range. Aperture window 760 may include one or more of optical diffusers, optical waveguides, optical retroreflectors, optical prisms, optical lens, etc. for processing detection portion 716 and/or non-detection portion 717. For instance, aperture window 760 may include optics for forming various light patterns based on the non-detection portion of the transmission light 717.

In FIG. 7A, as described above, the detection portion of the transmission light 716 is directed toward an FOV of system 700; and the non-detection portion of the transmission light 717 is directed toward an FOI of system 700. For instance, typically, the detection portion of the transmission light 716 is scanned by steering mechanism 740 to detect objects in the LiDAR detection range of the integrated system 700. The LiDAR's detection range may cover a distance of, for example, 0-200 m (or more) from the integrated system 700. The non-detection portion of the transmission light 717, on the other hand, may only need to illuminate an area a few meters or tens of meters from the vehicle having integrated system 700. In addition, for LiDAR detection, the FOV of system 700 may cover a horizontal area of 120 degrees or more. For illumination and/or signaling the FOI of system 700 may be smaller or larger than 120 degrees. The vertical coverage of the FOV and FOI may also be the same or different. Therefore, the overall FOV and the FOI of system 700 may be different. In some embodiments, they at least partially overlap. In some cases, they may not overlap.

As described above, vehicle lights may be generally divided into two types by functions: lights designed to illuminate environment and lights designed to display light patterns as indicators or warnings. The first type of lights is also referred to as illumination lights and the second type of lights is also referred to as signaling lights. Some vehicle lights may have both functions. Lights designed to illuminate environment may include headlights, backup lights, fog lights, day-time-driving lights, etc. Lights designed to display light patterns as indicators or warnings may include parking lights, direction-signal lights, backup lights, fog lights, blinker lights, tail lights, brake lights, hazard lights, etc.

FIG. 7B illustrates an example integrated system 700A, in which components of a LiDAR device is integrated with various example illumination light fixtures of a vehicle, according to some embodiments. FIG. 7C illustrates an example integrated system 700B, in which components of a LiDAR device is integrated with various example signaling light fixtures, according to some embodiments. Integrated system 700 described above can be used to implement integrated system 700A and/or 700B. For instance, each of system 700A and 700B may include light source(s), a transmitter, a steering mechanism, control circuitry, optical receiver and light detector, and an aperture window. For simplicity, these components are not repeatedly described. Integrated system 700A can transmit, via aperture window 760A, one or both of: detection portion of transmission light 716A toward an FOV and non-detection portion of transmission light 717A toward an FOI. And similarly, integrated system 700B can transmit, via aperture window 760B, one or both of detection portion of transmission light 716B toward an FOV and non-detection portion of transmission light 717B toward an FOI.

FIG. 7B shows that the integrated system 700A can combine components of a LiDAR device with illumination light fixtures of a vehicle. Such illumination light fixtures include LED headlights 701A, backup lights 701B, fog lights 701C, daytime-driving lights 701D, and/or other types of illumination light fixtures. As shown in FIG. 7B, different types of illumination light fixtures may have different shapes and sizes. Accordingly, the integrated system 700A may have different shapes and sizes too. It can generally fit or integrate various components of the LiDAR device (e.g., steering mechanism, transmitter, receiver, detector, etc.) to the illumination light fixtures. It may also share electrical circuit and power source with the illumination light fixtures. The light source in the integrated system 700A may also be arranged according to the design of the illumination light fixtures. For instance, the light source in an integrated system 700A may have multiple LED elements arranged in a 1D or 2D array to provide light in certain light patterns (e.g., the light patterns emitted by light fixtures 701A-701D).

FIG. 7C shows that the integrated system 700B can combine components of a LiDAR device with various signaling light fixtures of a vehicle. Such signaling light fixtures include parking lights 711A, direction-signal lights 711B, backup lights 711C, blinker lights 711D, and/or other types of signaling light fixtures. As shown in FIG. 7C, different types of signaling light fixtures may have different shapes and sizes. Accordingly, the integrated system 700B may have different shapes and sizes too. It can generally fit or integrate various components of the LiDAR device (e.g., steering mechanism, transmitter, receiver, detector, etc.) to the signaling light fixtures. It may also share electrical circuit and power source with the signaling light fixtures. The light source in the integrated system 700B may also be arranged according to the design of the signaling light fixtures. For instance, the light source in an integrated system 700B may have a non-linear array of LED elements arranged to provide light in certain light patterns (e.g., the light patterns emitted by light fixtures 711A-711D).

The various different exemplary vehicle light fixtures shown in FIGS. 7B and 7C (and other light fixtures not shown) can be integrated with components of one or more LiDAR devices to form integrated systems (e.g., systems 700B and 700C). These integrated systems 700B and 700C can fit into the space for mounting the vehicle light fixtures or assemblies. The integrated systems 700B and 700C thus may not increase the size and/or change the footprint of the vehicle light fixtures. Therefore, the integrated systems can be compact and energy efficient. With reference back to FIG. 1, the exemplary integrated LiDAR and vehicle light systems may be mounted to any of the positions 120A-120I on a vehicle, where typical vehicle light fixtures may be placed, or may be attached to any other positions that the vehicle may have vehicle light fixtures.

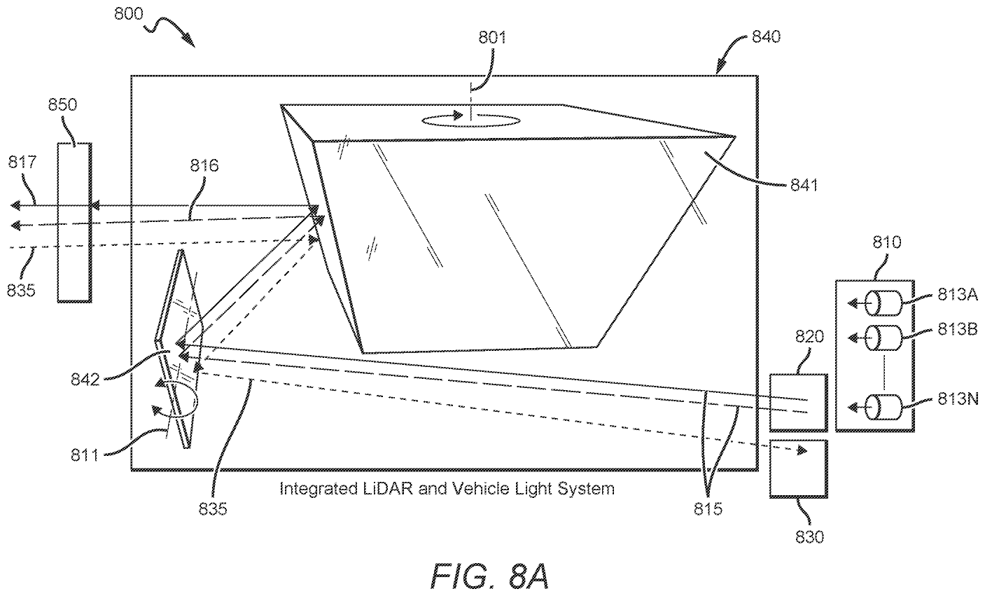

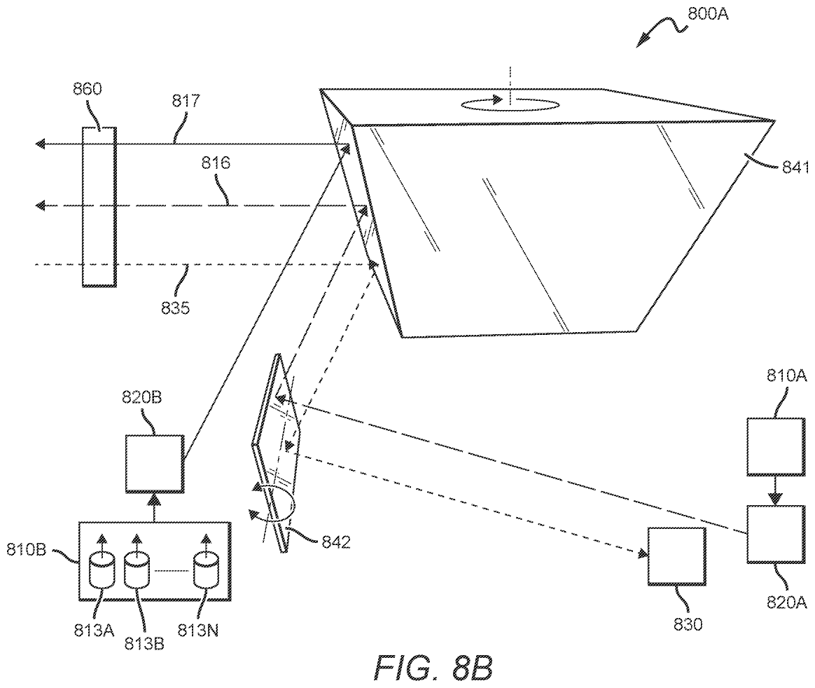

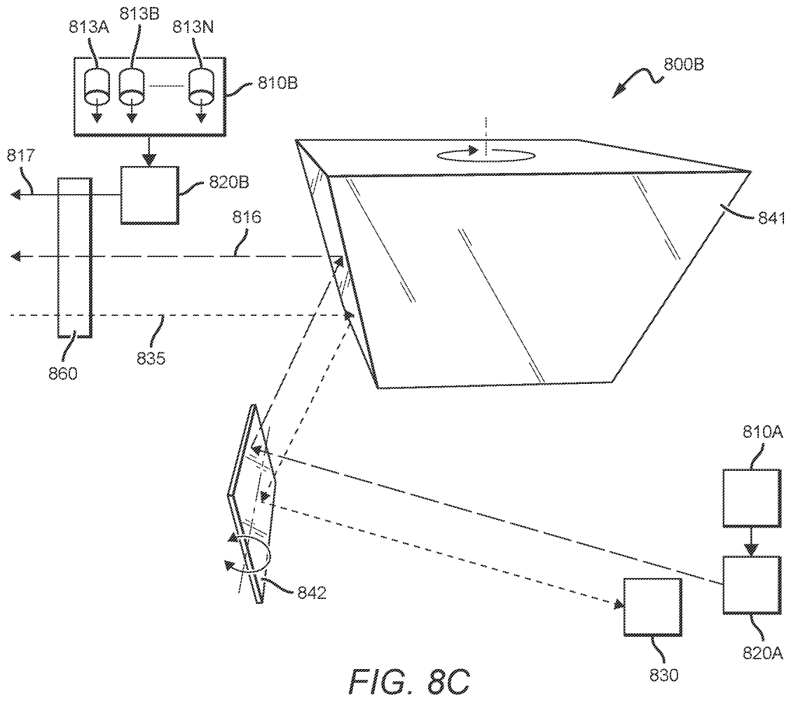

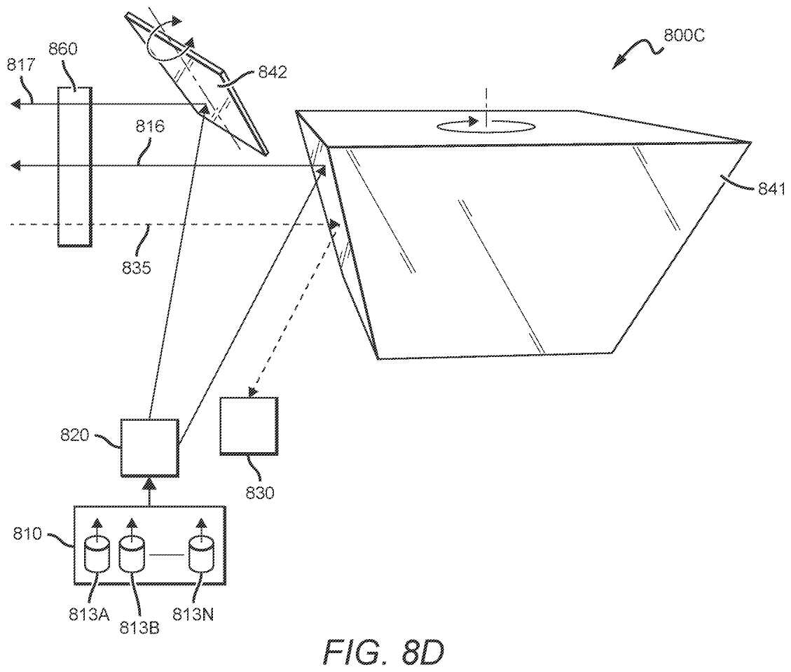

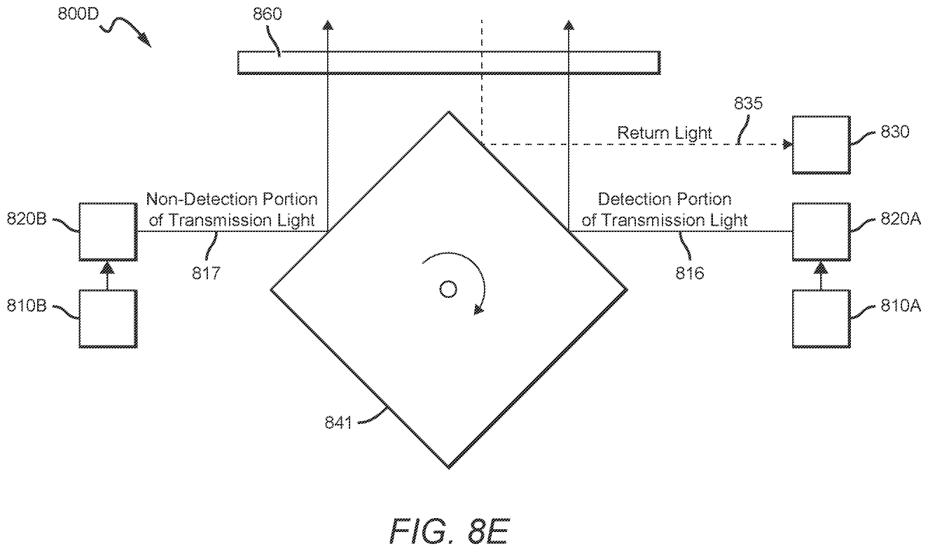

FIGS. 8A-8D are block diagrams illustrating example integrated LiDAR and vehicle light systems 800, 800A, 800B, and 800C, respectively, according to some embodiments. Systems 800, 800A, 800B, or 800C can be used to implement at least a part of systems 700, 700A, and 700B described above. With reference to FIG. 8A first, according to an embodiment, integrated LiDAR and vehicle light system 800 may include one or more light sources 810 providing transmission light 815 through a transmitter 820. In this example, light sources 810 include a first light source (e.g., a laser light source) configured to generate the detection portion of the transmission light and a second light source (e.g., LEDs) configured to generate the non-detection portion of the transmission light. FIG. 8A illustrates an array of light emitting elements 813A-813N (e.g., RGB LEDs) included in light sources 810. These light emitting elements 813A-813N can be used for generating the non-detection portion of the transmission light, and are described in more detail in FIGS. 10A-10B. The detection portion of the transmission light and the non-detection portion of the transmission light may have different wavelengths. Thus, transmission light 815 may include a mix of the detection portion and the non-detection portion. In another example, the detection portion and the non-detection portion may be kept separate in two separate transmitter channels provided by transmitter 820. Transmitter 820 can be substantially the same or similar to transmitter 720 or 320 described above.

With continued reference to FIG. 8A, transmission light 815 is directed to steering mechanism 840, which can be used to implement steering mechanism 740 or 340 described above. Steering mechanism 840 may steer the transmission light 815 toward an aperture window 850. In this example shown in FIG. 8A, steering mechanism 840 includes a polygon mirror 841 and a planar mirror 842. Polygon mirror 841 has a plurality of reflective facets (e.g., 4) and is configured to rotate about a rotation axis 801 for scanning light in one direction (e.g., the horizontal direction). Rotation axis 801 can be perpendicular to a top end or top surface of polygon mirror 841. Planar mirror 842 is configured to rotate or oscillate about an axis 811 for scanning light in another direction (e.g., the vertical direction). Axis 811 is an axis parallel to the longitudinal edge of planar mirror 842 or an axis about which the planar mirror 842 oscillates to scan vertically. In other embodiments, steering mechanism 840 may include only polygon mirror 841 but no planar mirror 842. For instance, the polygon mirror 841 may be a variable polygon mirror. The tilt angles of the plurality of reflective facets of a variable polygon mirror vary, thereby enabling the polygon mirror 841 to scan in both horizontal and vertical directions. A tilt angle of a reflective facet refers to the angle between the normal direction of the reflective facet and the rotational axis of the polygon mirror. In another example, steering mechanism 840 may have additional or different components (e.g., using two planar mirrors, two polygon mirrors, a prism instead of a polygon mirror, etc.). The disclosure herein uses the steering mechanism having a polygon mirror and a planar mirror as an example, but it is understood that other types of steering mechanism may also be used.

As described above, the transmission light 815 comprises a detection portion 816 and a non-detection portion 817. In this example shown in FIG. 8A, both portions are received and directed by polygon mirror 841 and planar mirror 842. Therefore, the optical paths of detection portion 816 and the non-detection portion 817 are co-axial. Both portions 816 and 817 are scanned by steering mechanism 840. In the example shown in FIG. 8A, both the detection portion 816 and non-detection portion 817 of the transmission light are transmitted from transmitter 820 to planar mirror 842. Planar mirror 842 redirects both portions 816 and 817 to polygon mirror 841. Polygon mirror 841 then scan both portions 816 and 817 out of aperture window 850. As shown in FIG. 8A, non-detection portion of the transmitted light 817 may cause light in the visible light spectrum to transmit out of the aperture window 850 as illumination light. The non-detection portion of the transmitted light 817 may be, for example, diffused by the aperture window 850 as vehicle signal lights. The steering mechanism 840 may be controlled to scan the non-detection portion of the transmitted light 817 on the aperture window 850 or another place to form visible light patterns. The forming of light patterns is described in more detail below.

The steering mechanism 840 may also be controlled to scan the detection portion of the transmitted light 816 in a scanning pattern such as a raster pattern through the aperture window 850 toward the external environment. If the detection portion of the transmitted light 816 impacts one or more objects in the external environment, it may cause return light 835 to be scattered or reflected back toward the integrated system 800 and may be received and detected by the optical receiver and light detector 830. In one example, the return light 835 is received first by polygon mirror 841. Polygon mirror 841 redirects the return light 835 to planar mirror 842, which in turn redirects the return light 835 to optical receiver and light detector 830. In some examples, optical receiver and light detector 830 can be substantially the same or similar to optical receiver and light detector 330 or 730 described above. For instance, it may include one or more receiving optics like a collection lens, optical fibers, optical filters, etc.; and one or more light detectors for detecting and converting optical signals to electrical signals. In one example, the detection portion of the transmitted light 816 may be in the IR light spectrum and the return light 835 may be in the IR light spectrum too.

In some embodiments, the non-detection portion of the transmitted light 817 from the light source 810 may be in the visible light spectrum, or may be in the non-visible light spectrum such as ultraviolet (UV). If the non-detection portion of the transmitted light 817 is in the visible light spectrum, it may be directed or focused by the aperture window 850, or other optics of integrated system 800, to be transmitted out as illumination light, such as a head light or fog light. It may also be scattered or diffused by the aperture window 850, or other optics of integrated system 800, so to form light patterns on the aperture window 850 as vehicle signal lights or warning lights. The aperture window 850 may include optical diffusers, optical lenses, optical waveguides, and/or optical retroreflectors.

If the non-detection portion of the transmitted light 817 is in the non-visible light spectrum such as ultraviolet (UV), the aperture window 850 may convert the non-detection portion of the transmitted light 817 from light in the non-visible light spectrum to light in the visible light spectrum transmitting out of the aperture window 850. The aperture window 850 may include UV fluorescent material that converts UV light of the non-detection portion of the transmitted light 817 into visible light in any desired colors. Such UV fluorescent material may also be non-absorbent of non-UV lights, so to allow the detection portion of the transmitted light 816 to pass through the aperture window 850. Alternatively or additionally, the aperture window 850 may have multiple portions or areas with different optical materials and structures such as UV fluorescent material, optical diffusers, optical lenses, optical waveguides, or optical retroreflectors, so to allow any combinations thereof. Examples of aperture window 850 are described in more detail below.

The detection portion of the transmission light 816 may pass through the aperture window 850 with less than 10% degradation in optical energy. As described above, the aperture window 850 may use materials and structures that are substantially transparent to the detection portion of the transmission light 816 (e.g., light in the IR spectrum). The steering mechanism 840 may include a polygon mirror 841, a planar mirror 842, a microelectromechanical systems (MEMS) mirror, an optical prism, and/or an optical lens. The polygon mirror 841, the planar mirror 842, the microelectromechanical systems (MEMS) mirror, the optical prism, and the optical lens may each rotate, oscillate, and/or remain stationary, to allow the steering mechanism 840 to direct the transmission light 815 in desired scanning patterns.

Furthermore, the non-detection portion of the transmission light 817 from the light source 810 may be controlled or modulated in a non-continuous way, such as transmitted in light pulses or varying intensities. The non-detection portion of the transmission light 817 from the light source 810 may have a temporal profile, or modulated according to a temporal profile, e.g., intensity or pulse width may be modulated based on time or based on a sequence code in time. For example, but not limited, the non-detection portion of the transmitted light 817 from the light source 810 may be modulated by pulse code modulation (PCM) or pulse width modulation (PWM).

FIG. 8B illustrates another integrated system 800A, which is a variation of system 800 shown in FIG. 8A. In FIG. 8B, an integrated system 800A also includes polygon mirror 841 and a planar mirror 842. System 800A has two light sources 810A and 810B and two corresponding transmitters 820A and 820B. The two light sources 810A-810B can be substantially the same as or similar to the first and second light sources in light sources 810 in FIG. 8A. For example, FIG. 8B illustrates an array of light emitting elements 813A-813N (e.g., RGB LEDs) included in light sources 810B. These light emitting elements 813A-813N can be used for generating the non-detection portion of the transmission light, and are described in more detail in FIGS. 10A-10B. Similarly, the transmitters 820A-820B can be substantially the same as or similar to transmitter 820 in FIG. 8A, e.g., when transmitter 820 includes multiple channels for directing the non-detection portion of the transmission light and the detection portion of the transmission light, as described above.

With reference to FIG. 8B, in system 800A, the non-detection portion of the transmission light 817 and detection portion of the transmission light 816 have two different optical paths. Specifically, light source 810A is configured to generate the detection portion of the transmission light 816, which is directed to transmitter 820A. Transmitter 820A directs the detection portion of the transmission light 816 to planar mirror 842, which in turn directs the detection portion 816 to polygon mirror 841. Polygon mirror 841 then scans the detection portion 816 out of aperture window 860. In a similar manner but reversed order, polygon mirror 841 and planar mirror 842 in system 800A also receive return light 835 and direct it to optical receiver and light detector 830. Thus, for the detection portion of the transmission light 816, the optical path in system 800A is the same as the optical path in system 800 shown in FIG. 8A.

For non-detection portion of transmission light 817, the optical path in system 800A is different from that in system 800. In FIG. 8B, light source 810B generates the non-detection portion 817, which is directed to transmitter 820B. Transmitter 820B in turn directs the non-detection portion 817 to polygon mirror 841 directly, without going through the planar mirror 842. Polygon mirror 841 then directs the non-detection portion of transmission light 817 out of aperture window 860. Similar to those described above, the non-detection portion 817 may be directed or focused by the aperture window 860, or other optics of integrated system 800A, to be transmitted out as illumination light, such as a head light or fog light. It may also be scattered or diffused by the aperture window 860, or other optics of integrated system 800A, so to form light patterns on the aperture window 860 as vehicle signal lights or warning lights. The aperture window 860, and/or the other optics of integrated system 800A, may include optical diffusers, optical lenses, optical waveguides, and/or optical retroreflectors. In this embodiment, the non-detection portion of transmission light 817 is only directed by polygon mirror 841, but not planar mirror 842. Therefore, the optical paths for the detection portion 816 and non-detection portion 817 only partially overlap.

FIG. 8C illustrates another integrated system 800B, which is another variation of system 800 shown in FIG. 8A. In FIG. 8C, an integrated system 800B also includes a polygon mirror 841 and a planar mirror 842. System 800B has two light sources 810A and 810B and two corresponding transmitters 820A and 820B. The two light sources 810A-810B can be substantially the same as or similar to the first and second light sources included in light sources 810 in FIG. 8A. For example, FIG. 8C illustrates an array of light emitting elements 813A-813N (e.g., RGB LEDs) included in light sources 810B. These light emitting elements 813A-813N can be used for generating the non-detection portion of the transmission light, and are described in more detail in FIGS. 10A-10B. Similarly, the transmitters 820A-820B in system 800B can be substantially the same as or similar to transmitter 820 in FIG. 8A, e.g., when transmitter 820 includes multiple channels for directing the non-detection portion of the transmission light and the detection portion of the transmission light, as described above.

With reference to FIG. 8C, in system 800B, the non-detection portion of the transmission light 817 and detection portion of the transmission light 816 also have two different optical paths. Specifically, light source 810A is configured to generate the detection portion of the transmission light 816, which is directed to transmitter 820A. Transmitter 820A directs the detection portion of the transmission light 816 to planar mirror 842, which in turn directs the detection portion 816 to polygon mirror 841. Polygon mirror 841 then scans the detection portion 816 out of aperture window 860. In a similar manner, polygon mirror 841 and planar mirror 842 in system 800B also receive return light 835 and direct it to optical receiver and light detector 830. Thus, for the detection portion of the transmission light 816, the optical path in system 800B is the same as the optical path in system 800 shown in FIG. 8A.

For non-detection portion of transmission light 817, the optical path in system 800B is different from that in systems 800 and 800A. In FIG. 8C, light source 810B generates the non-detection portion of transmission light 817, which is directed to transmitter 820B. Transmitter 820B sends the non-detection portion 817 directly out of aperture window 860. Similar to those described above, the non-detection portion 817 may be directed or focused by the aperture window 860, or other optics of integrated system 800B, to be transmitted out as illumination light, such as a head light or fog light. It may also be scattered or diffused by the aperture window 860, or other optics of integrated system 800B, so to form light patterns on the aperture window 860 as vehicle signal lights or warning lights. The aperture window 860, and/or the other optics of integrated system 800B, may include optical diffusers, optical lenses, optical waveguides, and/or optical retroreflectors. In this embodiment, the non-detection portion of transmission light 817 is not directed by either polygon mirror 841 or planar mirror 842, or any other components of a steering mechanism. Thus, the non-detection portion of the transmission light 817 is not scanned. Therefore, the optical paths for detection portion 816 and non-detection portion 817 do not overlap (at least not at the steering mechanism comprising polygon mirror 841 and planar mirror 842).

FIG. 8D illustrates another integrated system 800C, which is another variation of system 800 shown in FIG. 8A. In FIG. 8D, an integrated system 800C also includes polygon mirror 841 and planar mirror 842. System 800C has one light source 810 and one transmitter 820. The light source 810 can be substantially the same as or similar to light source 810 in FIG. 8A. For example, FIG. 8D illustrates an array of light emitting elements 813A-813N (e.g., RGB LEDs) included in light sources 810. These light emitting elements 813A-813N can be used for generating the non-detection portion of the transmission light, and are described in more detail in FIGS. 10A-10B. For example, it may include a first light source and a second light source for generating the detection portion and the non-detection portion of the transmission light respectively. It may also include just one light source for generating the transmission light, a portion of which can be converted to either the non-detection portion or the detection portion using other optics in system 800C (not shown) and/or aperture window 860. Similarly, the transmitter 820 can be substantially the same as or similar to transmitter 820 in FIG. 8A. For example, transmitter 820 in system 800C may include multiple channels for directing the non-detection portion of the transmission light and the detection portion of the transmission light, as described above.

With reference to FIG. 8D, in system 800C, the non-detection portion of the transmission light 817 and detection portion of the transmission light 816 also have two different optical paths. Specifically, light source 810 is configured to generate the detection portion of the transmission light 816, which is directed to transmitter 820. Transmitter 820 directs the detection portion of the transmission light 816 to polygon mirror 841, which in turn scans the detection portion 816 out of aperture window 860. Polygon mirror 841 in system 800C also receives return light 835 and directs it to optical receiver and light detector 830. In this embodiment, no planar mirror is used for the detection portion of transmission light 816, and as described above, the polygon mirror 841 in system 800C may be a variable angle polygon mirror for implementing two directional scanning. In this embodiment, for the detection portion of the transmission light 816, the optical path in system 800C is different from the optical paths in system 800, 800A, and 800B shown in FIGS. 8A-8C respectively.

For non-detection portion of transmission light 817, the optical path in system 800C is also different from that in systems 800, 800A, and 800B. In FIG. 8D, light source 810 generates the non-detection portion 817, which is directed to transmitter 820. Transmitter 820 sends the non-detection portion 817 to planar mirror 842, which in turn directs the non-detection portion 817 out of aperture window 860. Similar to those described above, the non-detection portion 817 may be directed or focused by the aperture window 860, or other optics of integrated system 800C, to be transmitted out as illumination light, such as a head light or fog light. It may also be scattered or diffused by the aperture window 860, or other optics of integrated system 800C, so to form light patterns on the aperture window 860 as vehicle signal lights or warning lights. The aperture window 860, and/or the other optics of integrated system 800C, may include optical diffusers, optical lenses, optical waveguides, and/or optical retroreflectors. In this embodiment, the non-detection portion of transmission light 817 is not directed by polygon mirror 841. Therefore, the optical paths for detection portion 816 and non-detection portion 817 do not overlap (at least not at the steering mechanism comprising polygon mirror 841 and planar mirror 842).

FIG. 8E illustrates another integrated system 800D, which is a variation of system 800 shown in FIG. 8A. In FIG. 8E, an integrated system 800D also includes polygon mirror 841 and a planar mirror 842. System 800A has two light sources 810A and 810B and two corresponding transmitters 820A and 820B. The two light sources 810A-810B can be substantially the same as or similar to the first and second light sources in light sources 810 in FIG. 8A. For example, in FIG. 8E, an array of light emitting elements (e.g., RGB LEDs) similar to elements 813A-813N (shown in FIGS. 8A-8D) can also be included in light sources 810B. These light emitting elements can be used for generating the non-detection portion of the transmission light, and are described in more detail in FIGS. 10A-10B. Similarly, the transmitters 820A-820B can be substantially the same as or similar to transmitter 820 in FIG. 8A, e.g., when transmitter 820 includes multiple channels for directing the non-detection portion of the transmission light and the detection portion of the transmission light, as described above.

With reference to FIG. 8E, in system 800D, the non-detection portion of the transmission light 817 and detection portion of the transmission light 816 have two different optical paths. Specifically, light source 810A is configured to generate the detection portion of the transmission light 816, which is directed to transmitter 820A. Transmitter 820A directs the detection portion of the transmission light 816 to a first reflective facet of polygon mirror 841, which in turn directs the detection portion 816 toward aperture window 860 (or another optics like a planar mirror). The polygon mirror 841 (or a combination of polygon mirror 841 and a planar mirror) scans the detection portion 816 out of aperture window 860. Polygon mirror 841 in system 800D also receives return light 835 and direct it to optical receiver and light detector 830.

For non-detection portion of transmission light 817, the optical path is different from that of detection portion of transmission light 816. In FIG. 8E, light source 810B generates the non-detection portion 817, which is directed to transmitter 820B. Transmitter 820B in turn directs the non-detection portion 817 to a second facet of polygon mirror 841, with or without going through other optics like planar mirror 842. The second facet is a different facet (e.g., an adjacent facet, an opposite facet, etc.) from the first facet, to which the detection portion 816 is directed. Polygon mirror 841 then directs the non-detection portion of transmission light 817 out of aperture window 860. Similar to those described above, the non-detection portion 817 may be directed or focused by the aperture window 860, or other optics of integrated system 800D, to be transmitted out as illumination light, such as a head light or fog light. It may also be scattered or diffused by the aperture window 860, or other optics of integrated system 800D, so to form light patterns on the aperture window 860 as vehicle signal lights or warning lights. The aperture window 860, and/or the other optics of integrated system 800D, may include optical diffusers, optical lenses, optical waveguides, and/or optical retroreflectors. In this embodiment, the non-detection portion of transmission light 817 and the detection portion of transmission light 816 are directed by two different facets of polygon mirror 841. Therefore, the optical paths for the detection portion 816 and non-detection portion 817 are different and may not overlap at all.

While FIGS. 8A-8E illustrate several example configurations of the optical paths of the detection portion 816 and non-detection portion 817 of the transmission light, it is understood that other configurations can also be implemented, depending on the type of application, LiDAR scanning requirements, and vehicle light illumination and/or signaling requirements. In some cases, the requirements for LiDAR scanning and the requirements for vehicle light illumination and/or signaling requirements can be different. As described above, the LiDAR scanning range may be configured to detect objects in both horizontal and/or vertical directions within certain distances, while the vehicle light may be configured to provide certain light patterns for signaling or for illumination of a road surface, nearby pedestrians or other vehicles. As a result, the FOV of the integrated system for LiDAR scanning and the FOI of the integrated system for vehicle illumination/signaling may or may not overlap. Accordingly, the optical paths for the non-detection portion 817 and detection portion 816 may not need to be the same or coaxial. The spectrums of the non-detection portion 817 and the detection portion 816 may also be different. For instance, the non-detection portion 817 may be in the visible light spectrum or UV light spectrum, while the detection portion 816 may be in the IR light spectrum. Therefore, the non-detection portion 817 and the detection portion 816 may not go through the same optics or the same sequence of the optics in an integrated system (e.g., system 800 or 800A-800C).

As described above, a light source (e.g., light source 710 or 810) may generate light with one or more wavelengths or wavelength ranges. In an integrated LiDAR and vehicle light system, the detection portion and non-detection portion of the transmission light are used for LiDAR detection and for vehicle illumination/signaling, respectively. The detection portion and non-detection portion may have different wavelengths or wavelength ranges, e.g., one in IR spectrum and one in visible spectrum. Thus, if a light source in an integrated system generates transmission light in one wavelength or wavelength range (e.g., only IR light or only visible light, but not both), at least a portion of the transmission light needs to be converted (e.g., from IR light to visible light, or vice versa) to obtain the light in the other wavelength or wavelength range. In another example, if the light source generates light in two or more different wavelengths or wavelength ranges, but one or more of the wavelengths or wavelength ranges do not meet the required wavelength or wavelength range for either the detection portion or the non-detection portion of the transmission light, wavelength conversion may also be performed for at least a portion of the transmission light. For instance, if the light source generates UV light for the non-detection portion of the transmission light, the UV light may need to be converted to visible light to be used as illumination and/or signaling for the vehicle.

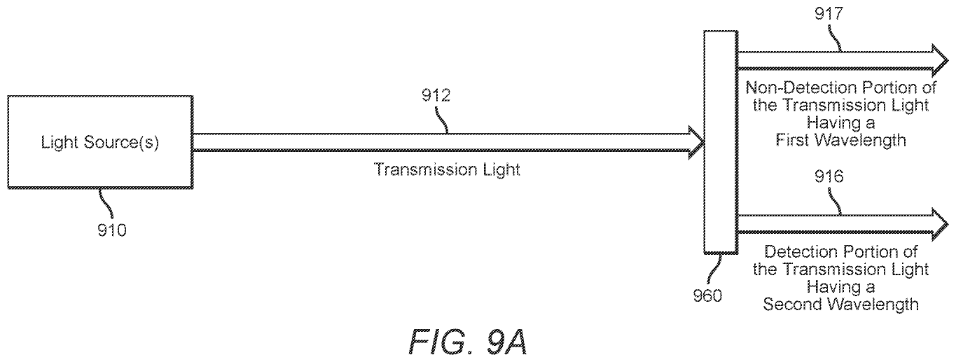

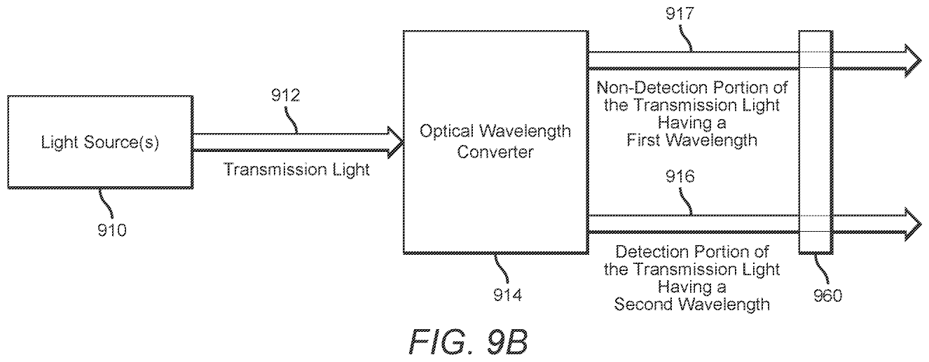

FIG. 9A is a block diagram illustrating an aperture window 960 configured to perform wavelength conversion, according to some embodiments. Aperture window 960 can be used to implement aperture window 760, 760A, 760B, 850, or 860. For simplicity, FIG. 9A omits other components between the light sources 910 and aperture window 960, including, for example, a transmitter, a steering mechanism, etc. The aperture window 960 is configured to generate, based on the transmission light 912 provided by light source(s) 910, at least one of the non-detection portion of the transmission light and the detection portion of the transmission light. In one embodiment, if transmission light 912 is in the wavelength or wavelength range of the detection portion of the transmission light 916, aperture window 960 can convert a portion of the transmission light 912 to obtain the non-detection portion of the transmission light 917. In another embodiment, if transmission light 912 is in the wavelength or wavelength range of the non-detection portion of the transmission light 917, aperture window 960 can convert a portion of the transmission light 912 to obtain the detection portion of the transmission light 916. In another embodiment, if transmission light 912 is not in either the wavelength or wavelength range of the non-detection portion of the transmission light 917 or the detection portion of transmission light 916, aperture window 960 can convert a portion of the transmission light 912 to obtain the detection portion of the transmission light 916 and convert another portion of transmission light 912 to obtain the non-detection portion of the transmission light 917.

In one example, aperture window 960 can convert IR light to visible light. In some embodiments, aperture window 960 may include phosphors, which are materials that absorb higher-energy photons (such as those in the IR range) and re-emit them as lower-energy photons in the visible range. In one example, aperture window 960 may include up-conversion phosphors, which are materials that can absorb two or more lower-energy IR photons and then emit one higher-energy visible photon. This process allows the conversion of longer-wavelength IR light into shorter-wavelength visible light. In another example, aperture window 960 may include dye-sensitized solar cells (DSSCs), which are photovoltaic devices used to convert sunlight into electricity. They use dyes that absorb both visible and near-infrared light and then transfer that energy to the semiconductor layer, where it generates electric current. While the primary purpose of DSSCs is electricity generation, they also convert some IR light into visible light as a side effect. In another example, aperture window 960 can include phosphorescent materials, which can convert a portion of IR light into visible light. These materials absorb IR photons and then re-emit them as visible light.

In another example, aperture window 960 can include nonlinear optical structures for converting IR light to visible light through processes like second-harmonic generation (SHG) or sum-frequency generation (SFG). The nonlinear optical structures may have specific properties that allow them to mix two or more photons of different wavelengths to produce new photons at shorter wavelengths in the visible range. One example of a nonlinear optical structure is an optical frequency multiplier, which is a nonlinear optical device in which photons interacting with a nonlinear material are effectively combined to form new photons with greater energy, and thus higher frequency (and shorter wavelength). Two types of devices may be used as a frequency multiplier: frequency doublers, often based on lithium niobate (LN), lithium tantalate (LT), potassium titanyl phosphate (KTP) or lithium triborate (LBO), and frequency triplers typically made of potassium dihydrogen phosphate (KDP).

In the situation where light source 910 generates transmission light 912 in the visible spectrum, aperture window 960 can be configured to convert a portion of transmission light 912 to IR light for using as the detection portion of the transmission light 916. In some embodiments, aperture window 960 can include nonlinear optics that perform nonlinear optical processes such as optical parametric amplification (OPA) or sum-frequency generation (SFG). The nonlinear optical processes can be used to generate IR light from visible light. These processes rely on specific nonlinear optical materials that can mix two or more photons of different wavelengths to produce new photons at longer wavelengths in the IR range.

In another example, aperture window 960 may include phosphors with infrared emission. Certain phosphorescent materials are designed to absorb visible light and then re-emit it as IR light. For example, the visible light from an LED source may be converted into IR light using the phosphorescent materials. In another example, aperture window 960 may include nonlinear crystals, such as potassium titanyl phosphate (KTP) or periodically-poled lithium niobate (PPLN), which can be used to convert visible light into IR light through processes like difference frequency generation (DFG). These materials can create IR light based on the interaction of two or more incident photons of shorter wavelengths.

As described above, if transmission light 912 has UV light, aperture window 960 can also convert the UV light to visible light using, for example, fluorescent glasses. The above are just examples of different ways an aperture window 960 can be implemented to convert light from one wavelength to another. It is understood that other conversion ways can also be used for aperture window 960.

FIG. 9B is a block diagram illustrating an optical wavelength converter 914 configured to perform wavelength conversion, according to some embodiments. Compared to the embodiment shown in FIG. 9A, an optical wavelength converter 914 is placed between light source(s) 910 and aperture window 960. The optical wavelength converter 914 can perform at least some of the same wavelength conversion functions of aperture window 960. Thus, in this embodiment, aperture window 960 receives the detection portion 916 and the non-detection portion 917 from optical wavelength converter 914, and may not need to perform further conversions. Optical wavelength converter 914 can include structures and materials described above for the aperture window 960. Thus, these structures and materials can be incorporated into converter 914 and/or aperture window 960 to perform wavelength conversion. As described above, one such structure uses non-linear optics like non-linear crystals. It is understood that for simplicity, FIG. 9B does not show other components of an integrated system, including, for example, a transmitter, a steering mechanism, etc. And the optical wavelength converter 914 can be placed anywhere inside an integrated system (e.g., system 700, 800, 800A-800C). For example, it can be placed immediately after the light source, between the light source and the transmitter, between the transmitter and the steering mechanism, inside the steering mechanism (e.g., between a polygon mirror and a planar mirror), between the steering mechanism and the aperture window, or immediately in front of the aperture window, etc.

FIG. 10A is a block diagram illustrating an example array of light emitting elements 1010 and an aperture window 1060 including an optical diffuser for forming a light pattern using the non-detection portion of the transmission light, according to some embodiments. For simplicity, other components used in an integrated LiDAR and vehicle light system are omitted in FIG. 10A. Thus, there may be other components such as transmitter, steering mechanism, etc. disposed between light emitting elements 1010 and aperture window 1060. As shown in FIG. 10A, light emitting elements 1010 can be used in any of the light sources 710, 810, 810A-810B, or 910. Light emitting elements 1010 can include one or more of: light emitting diodes (LEDs), organic LEDs, laser diodes, fluorescent-based light elements, incandescent-based light elements, phosphorescent-based light elements, electroluminescent-based light elements, photoluminescent-based light elements, etc.

Depending on the desired light pattern for vehicle illumination/signaling and/or for satisfying the LiDAR scanning requirements (e.g., the scanning ranges in the horizontal and vertical directions), light emitting elements 1010 and the aperture window 1060 can be arranged differently with respect to each other. In one example as shown in FIG. 10A, for LiDAR scanning, the detection portion of the transmission light is to be transmitted through the center portion 1060B of aperture window 1060. And for vehicle illumination/signaling, the non-detection portion of the transmission light is to be transmitted through the peripheral portion 1060A of aperture window 1060. The light source used in such an integrated system may include a plurality of light emitting elements 1010A-1010N (collectively as 1010). Light emitting elements 1010A-1010N can be used to implement light emitting elements 713A-713N and/or 813A-813N described above using FIGS. 7A and 8A-8E. In the example shown in FIG. 10A, light emitting elements 1010A-1010N can be positioned in places corresponding to the peripheral portion 1060A of aperture window 1060. For instance, if aperture window 1060 has a square or rectangle shape, the light emitting elements 1010A-1010N can be arranged to form 1D arrays, with each array being placed corresponding to one edge of aperture window 1060. In another example, if aperture window 1060 has a circular shape, the light emitting elements 1010A-1010N can form a ring positioned at places corresponding to the circular edge of the aperture window 1060. As a result, the non-detection portion of the transmission light can be emitted through aperture window 1060 at the peripheral portion 1060A to form a desired illumination/signaling pattern (e.g., a circular ring pattern/a square pattern, etc.). In this example shown in FIG. 10A, light emitting elements 1010 may be the light source for providing only the non-detection portion of the transmission light. There may be another light source (not shown) for providing the detection portion of the transmission light. Such a light source can be placed at a position corresponding to the center portion 1060B of aperture window 1060, so that the detection portion of the transmission light is emitted through the center portion 1060B.

It is understood that FIG. 10A only illustrates one possible arrangement of the detection portion and the non-detection portion of the transmission light. Other arrangements can also be implemented. For instance, the detection portion of the transmission light can be emitted through the peripheral portion 1060A while the non-detection portion of the transmission light can be emitted through the center portion 1060B of aperture window 1060. The detection portion and the non-detection portion of the transmission light may also be emitted through a same portion of aperture window 1060, because they have different wavelengths or wavelength ranges. In another example, the detection portion of the transmission light may be emitted from the upper portion of aperture window 1060 while the non-detection portion of the transmission light may be emitted from the lower portion of aperture window 1060. Depending on the desired arrangement of the detection portion and the non-detection portion of the transmission light, the light emitting elements 1010A-1010N and/or a second light source can be arranged correspondingly. In one embodiment, the light emitted from light emitting elements 1010A-1010N may be used for both the detection portion and the non-detection portion of the transmission light, by converting at least a portion of the light as described above. Thus, in this case, there may not be a second light source.

In some embodiments, the light emitting elements 1010A-1010N can form a linear array. The array may comprise 8, 10, 12, 16, 24, 32, 64, etc. light emitting elements arranged in horizontal and/or vertical directions. The light emitting elements 1010A-1010N may also form 2-dimensional matrix or any other desired patterns (e.g., ring shaped, square, arrow-shaped, circular shaped, oval shaped, etc.), depending on the illumination and signaling requirements for the vehicle. For instance, at least some of the light emitting elements 1010A-1010N can be arranged to form a left pointing arrow light pattern, a right pointing arrow light pattern, a U-shaped arrow light pattern, a lane-changing light pattern, etc., for signaling a left turn, a right turn, a U-turn, a lane-changing, respectively. Other patterns can also be formed.

In one embodiment, the light emitting elements 1010A-1010N can form an array (e.g., a linear array or a non-linear array) or a matrix (e.g., a 2D or 3D matrix). Each of the light emitting elements in the array or the matrix can be individually or independently controlled (e.g., by control circuitry 350 or 750 described above) to turn on, turn off, stay on for certain time periods, stay off for certain time periods, blink at certain frequency, change color, change brightness, change contrast, etc. Each light emitting element may also be configured to emit light in any color. For example, each light emitting element may include color-changing LEDs or RGB (Red-Green-Blue) LEDs by adjusting the intensity of the three primary color components (red, green, and blue). Thus, light emitting elements 1010A-1010N can use different or same colors depending on the control signals. For instance, in an integrated LiDAR and vehicle light system disposed as a vehicle rear-end signaling light, certain light emitting elements disposed in a linear array may be turned on and controlled to emit red colors one at a time from right to left, or from left to right, to signal a left turn or a right turn, respectively. The similarly-arranged light emitting elements disposed as a vehicle front-end signaling light may use a different color (e.g., an orange color or yellow color). As another example, if an integrated LiDAR and vehicle light system is disposed as a fog light, the light emitting elements 1010A-1010N may be configured to emit a wide and low-intensity beam of light for better penetration of the fog and for reducing reflection and glare.

In another embodiment, each of the light emitting elements 1010A-1010N in an array or the matrix can be individually or independently controlled to emit light having the same or different wavelengths, same or different intensities, same or different directions, etc. For instance, if an integrated LiDAR and vehicle light system is disposed as a vehicle's high-beam headlight, at least some of the light emitting elements 1010A-1010N can be controlled to emit a higher intensity beam that is more collimated and focused to reach a far distance. The light emitting elements 1010A-1010N can be differently configured if they are used in a near-distance headlight or a parking light, etc. A sub-group of light emitting elements 1010A-1010N can also be controlled or modulated to change the direction of the vehicle illumination (e.g., straight ahead, toward the left, toward the right, upward, downward, etc.) In some embodiments, the light emitting elements 1010 can be configured differently according to control signals based on the LiDAR detections, as described in more detail below.

With reference to FIG. 10A, in some embodiments, an optical diffuser can be included in aperture window 1060 to further facilitate forming a desired light pattern or lighting effects for vehicle illumination and/or signaling. An optical diffuser can be a device or element used to scatter or diffuse light. An optical diffuser can be used to create a desired distribution of light by breaking up at least a portion of the transmission light into a broader and less intense illumination pattern. As shown in FIG. 10A, an aperture window 1060 may include an optical diffuser in the peripheral portion 1060A. The optical diffuser can change the direction of some beams more than other beams, and/or re-shape some of the beams, to create an uneven distribution of the light beams. It can diffuse light by scrambling the optical wavefronts and reducing its spatial coherence. Thus, optical diffuser can obtain changes of optical phases for different parts of the profile of the incident light beams. The optical diffuser can be made from various materials, including glass, plastic, and film. They can be customized with specific patterns or textures that scatter incoming light. These patterns can vary in complexity, ranging from simple rough surfaces to more sophisticated microstructure designs. The optical diffuser integrated in aperture window 1060 can thus comprise surfaces having micro-optical structures configured to receive evenly distributed light beams and form an uneven distribution of the light beams. The formation of the uneven distribution of light beams can be precisely controlled (by using the micro-optical patterns). The optical diffuser can therefore achieve specific lighting effects or light patterns, and improve the quality of illumination for an integrated LiDAR and vehicle light system. The choice of diffuser type and design depends on the specific requirements of integrated LiDAR and vehicle light system, including the desired level of diffusion and the intended lighting effect or light pattern.

FIG. 10B is a block diagram illustrating example light emitting elements 1010 and a back-illumination micro-lenses array 1070 for forming a desired light pattern using the non-detection portion of the transmission light, according to some embodiments. The embodiment shown in FIG. 10B is a variation of the embodiment shown in FIG. 10A. Additionally or alternatively, aperture window 1060 may include a wafer 1061 and micro-lenses array 1070. Like the configuration in FIG. 10A, an integrated LiDAR and vehicle light system may include light emitting elements 1010. The transmission light beams are emitted by one or more of these elements 1010. The integrated LiDAR and vehicle light system may also include an aperture window 1060 having a semiconductor wafer 1061 and a micro-lenses array 1070. The micro-lens array 1070 is configured to distribute the transmission light beams in a manner to form a desired light pattern or lighting effect.

Semiconductor wafer 1061, also simply referred to as wafer 1061, is a thin, flat, and typically circular slice of semiconductor material, such as silicon, that serves as the substrate for the fabrication of electrical and/or optical devices like a micro-lens array. Wafer 1061 can be silicon based (e.g., silicon, silicon carbide) or based on other semiconductor materials (e.g., gallium nitride based). The semiconductor wafer 1061 is transparent to the transmission light beams 1015 emitted by light emitting elements 1010 at a certain wavelength or wavelength range, such that light beams 1015 can pass through wafer 1061 and enter micro-lenses array 1070. In other words, the light beams 1015 can enter from the back side of wafer 1061 and come out from the front side through the micro-lenses array 1070. This configuration is also referred to as the back-illuminated technology. For example, a silicon based wafer is transparent for light beams having a wavelength of 905 nm. In some embodiments, the light emitting elements 1010 may also be disposed on the one surface (e.g., the back surface) of wafer 1061; and micro-lenses array 1070 can be disposed on the other surface (e.g., the front surface) of wafer 1061. In other embodiments, the light emitting elements 1010 can be separate and distinct from wafer 1061. While FIG. 10B uses a wafer 1061 as an example, other substrate for disposing micro-lenses array 1070 can also be used, such as glass, plastic, etc.

Micro-lenses in array 1070 are miniature lenses with a very small size, typically on the order of micrometers (μm) or even smaller. Micro-lenses can thus be much smaller than traditional lenses, and therefore, they can be disposed easily into a semiconductor wafer (or another substrate), making the integrated LiDAR and vehicle light system compact. Micro-lenses in array 1070 can be made from various materials, including glass, polymers, or semiconductor materials. The choice of material depends on the type of wafer 1061 and specific optical requirements. As shown in FIG. 10B, micro-lenses in array 1070 can shape and redirect light beams 1015. When a beam passes a particular micro-lens in array 1070, the light beam may or may not change direction. For instance, when the topmost light beam passes through the topmost micro-lens 1070A, the beam may be slightly bent upward. Similarly, when other beams pass through their respective micro-lenses 1070B-1070N, their directions can be maintained or changed to form a specific light pattern or lighting effects. Thus, in one embodiment, each different micro-lens may be configured differently to bend the respective transmission light beam to its intended directions.

While FIG. 10B illustrates that each of micro-lenses 1070A-1070N is configured to distribute one of the transmission light beams 1015, it is understood that in other embodiments, a subset of micro-lenses of the array 1070 can be configured to distribute one light beam. For instance, a group of two, three, four, or more micro-lenses 1070 can be arranged together to receive one light beam 1015 and redistribute the light beam to provide one output light beam. Multiple micro-lenses can form a sub-array (1D or 2D) or a sub-group that is placed at the proper location such that a transmission light beam can be received by the sub-array or sub-group of micro-lenses. The combination of the sub-groups of micro-lenses can thus collectively form a desired light pattern or lighting effects for vehicle illumination and/or signaling.

Micro-lenses array 1070 can be manufactured on a semiconductor wafer 1061 via various semiconductor processing technologies. In one example, the surface of a semiconductor wafer 1061 can be processed to form the micro-lenses array 1070 by removing materials from the surface to form the micro-lenses. Removing materials (e.g., silicon, oxide, metal, etc.) from wafer 1061 can be performed via photolithography (e.g., for patterning), chemical etching (e.g., dry etching or wet etching), and/or precision machining (e.g., chemical-mechanical polishing). In another example, a surface of the semiconductor wafer 1061 is processed to form the micro-lens array 1070 by depositing materials to the surface to form the micro-lenses. The materials deposited may comprise, for example, polymer materials, silicon materials, glass materials, plastic materials, etc. Deposit technologies can include physical vapor deposition (PVD), chemical vapor deposition (CVD), atomic layer deposition (ALD), electrochemical deposition, spin coating, sputtering, chemical solution deposition, etc. As one example, tiny droplets of polymer can be deposited to the surface of wafer 1061 to form the micro-lenses with subsequent thermal processes.

FIG. 10B illustrates that the micro-lenses array 1070 is integrated with an aperture window 1060. It is understood that the wafer 1061 and micro-lenses 1070 can form a light patterning optics that is distinct and separate from aperture window 1060. Similarly, the diffuser described using FIG. 10A does not need to be integrated into aperture window 1060, and can be a distinct and separate optical component for light patterning. One or more of an optical diffuser, a wafer/micro-lenses array, an aperture window, and any other optics for forming a desired light pattern or creating a desired lighting effect are referred to as a light patterning optics. FIG. 10C shows such a light patterning optics 1060.

FIG. 10C is a block diagram illustrating example light emitting elements 1010, light patterning optics 1060, and one or more optical modulators 1080 for forming a light pattern using the non-detection portion of the transmission light, according to some embodiments. Light emitting elements 1010 are the same or similar to that described above in FIGS. 10A and 10B. Light patterning optics 1060 can be any one or more of: an optical diffuser, a wafer/micro-lenses array, an aperture window, an optical waveguide, an optical retroreflector, etc. Examples of the diffuser, wafer/micro-lenses array, and their integration with the aperture window are described above. Light patterning optics 1060 can also be an optical waveguide, which is a physical structure that guides and confines electromagnetic waves, particularly in the visible or infrared (IR) part of the electromagnetic spectrum. An optical waveguide can perform light confinement using a core layer and cladding layers, such that the light is confined substantially in the core layer. Optical waveguides can include, for example, optical fibers, planar waveguides, photonic crystal waveguides, etc. Similar to the optical diffuser and micro-lenses, optical waveguides can also change the direction of the transmission light beams. Therefore, optical waveguides can also be used to form certain light patterns or lighting effects for vehicle illumination and/or signaling.

Optical retroreflector is another type of light patterning optics 1060. An optical retroreflector, also referred to as a retroreflector or corner-cube prism, is a specialized optical device designed to reflect incoming light or electromagnetic waves back toward the source, regardless of the angle of incidence. Optical retroreflectors may be used in combination with other light patterning optics such as waveguides to generate light patterns. For example, optical retroreflectors may be particularly useful when generating signaling lights.

With reference still to FIG. 10C, an integrated LiDAR and vehicle light system (e.g., system 700, 800, 800A-800C) may include one or more optical modulators 1080 for modulating the non-detection portion of the transmission light. The non-detection portion of the transmission light emitted from the light emitting elements 1010 may be controlled or modulated, by the one or more optical modulators 1080, in a non-continuous way, such as transmitted in pulses or varying intensities. The non-detection portion of the transmission light may have a temporal profile, or modulated by modulators 1080 according to a temporal profile, e.g., intensity or pulse width may be modulated based on time or based on a sequence code in time. For example, but not limited, the non-detection portion of the transmitted light may be modulated by pulse code modulation (PCM) or pulse width modulation (PWM).

Optical modulator 1080 may be a device or component used in optical systems and photonics to modulate the properties of an optical signal. Modulation involves changing one or more characteristics of an optical wave, such as its amplitude, phase, frequency, or polarization, or a combination thereof, to encode information for transmission. Optical modulator 1080 can be an amplitude modulators, which changes the intensity or amplitude of an optical signal. Examples include electro-absorption modulators (EAMs) and Mach-Zehnder modulators (MZMs). Optical modulator 1080 can also be a phase modulator, which alters the phase of an optical signal for encoding information. Lithium niobate modulators are common phase modulators. Optical modulator 1080 can also be a frequency modulators (FM), also referred to as electro-optic frequency shifters. An FM changes the frequency of an optical signal. Acousto-optic modulators (AOMs) are one type of FM device. Optical modulator 1080 can also be a polarization modulator, which varies the polarization state of light. By modulating the amplitude, phase, frequency, polarization, or a combination thereof of the non-detection portion of transmission light (and/or the detection portion), optical modulator 1080 can be used to assist in forming specific light patterns or manipulating the transmission light in a desired manner (e.g., controlling the directions, phases, timing, frequency, etc.).

FIG. 10D is a block diagram illustrating example light emitting elements 1012, light patterning optics 1060, and one or more optical modulators 1080 for forming a light pattern using the non-detection portion of the transmission light, according to some embodiments. FIG. 10D is similar to FIG. 10C, except that the light emitting elements 1012 form a 2-dimensional array. For example, multiple one-dimensional arrays of the light emitting elements can be arranged horizontally to form the two-dimensional array. The one-dimensional arrays or the light formed thereby can be coaxial or non-coaxial. Each of the light emitting elements, or a subgroup, of the two-dimensional array can be controlled independently (e.g., some of the elements are controlled to be on, some are controlled to be off) to form a desired light pattern using the light patterning optics 1060 and/or optical modulator 1080, in a similar manner described above. The control of these light emitting elements 1012 can be performed using control circuitry (e.g., circuitry 350 or 750 described above).

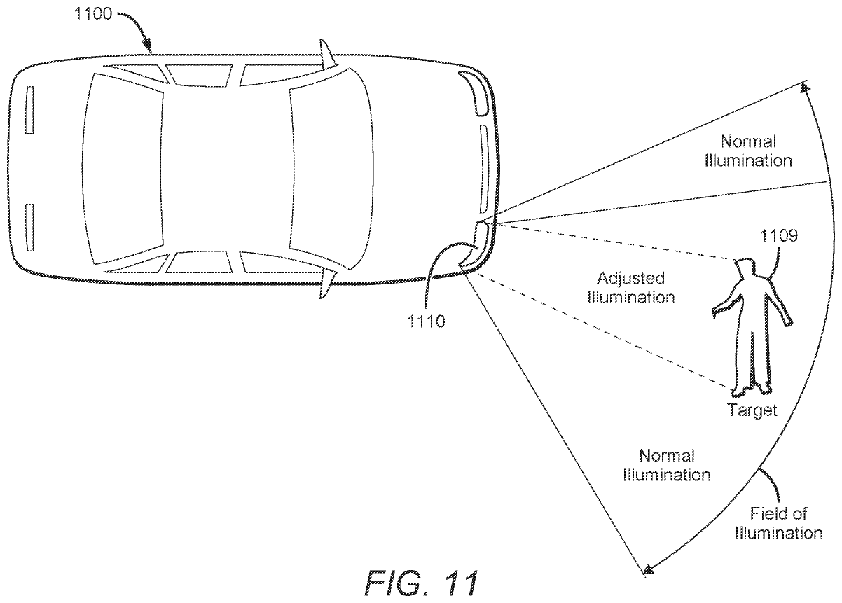

FIG. 11 is a diagram illustrating adjusting illumination on a human being according to some embodiments. As shown in FIG. 11, a vehicle 1100 is mounted with multiple integrated LiDAR and vehicle light systems. One such system is shown as system 1110, which is mounted to the vehicle 1100's front right corner. System 1110 can be any one of systems 700, 800, 800A-800C described above. The following disclosure for FIG. 11 uses this system 1110 as an example, but it is understood that the disclosure also can be used for other such integrated systems mounted to other part of vehicle 1100.

Integrated system 1110 can generate transmission light by one or more light sources. The transmission light can include a detection portion and a non-detection portion. Both portions can be transmitted out by, for example, a steering mechanism and/or other optics as described above. In one example, as shown in FIG. 11, the non-detection portion of the transmission light is used to illuminate a field-of-illumination (FOI) of system 1110. In the FOI, there may be one or more objects. A human being 1109 may be located in this FOI. The human being 1109 may also be located in the field-of-view (FOV) of system 1110, and is LiDAR detectable. Thus, human being 1109 may be detected by the integrated LiDAR and vehicle light system 1110 based on the return light formed by scattering or reflecting the detection portion of the transmission light by human being 1109. The return light is received by an optical receiver and light detector of system 1110, which converts the optical signals to electrical signals. The electrical signals are further processed by control circuitry to form a 3D point cloud. The 3D point cloud data may be further processed (e.g., by a processor in system 1110 or a vehicle perception and planning system (e.g., system 220 described above)). The processed data can be used to determine whether a detected object is a human being (or a live animal) or some other objects.

In response to a detection that the object is a human being (e.g., human being 1109), integrated system 1110 can control the projection or illumination of the human being to avoid blinding the human being 1109 or projecting light directly onto human being 1109. As shown in FIG. 11, in one example, system 1110, via its control circuitry (e.g., circuitry 750), can send a control signal to one or more components of system 1110 (e.g., the light source, the transmitter, the steering mechanism, an optical modulator, etc.) to adjust a part of the non-detection portion of the transmission light to obtain an adjusted level of illumination. The adjusted level of illumination may be, for example, a dimmed illumination (e.g., at 80%, 70%, 50%, 30%, etc. of the maximum light intensity), no illumination, a blinking illumination, or a combination of a dimmed illumination and a blinking illumination. The system 1110 projects the non-detection portion of the transmission light (e.g., visible light) at the adjusted level of illumination to the human being 1109 or a surrounding area of human being 1109. In one example, the adjusted level of illumination is only applied to the area where the human being 1109 is, but not other areas. For instance, in FIG. 11, the other areas within the field-of-illumination of system 1110 are still illuminated with the normal level of illumination (e.g., not dimmed or blinking).

In some embodiments, the illumination level can be adjusted based on the distance of the object. For example, if an object in the FOI of system 1110 is far away from vehicle 1100, the illumination level can be increased (or slightly reduced if the object is a human being). If an object is near vehicle 1100, the illumination level may be reduced from the normal level or maximum level (or significantly reduced if the object is a human being). The distance to an object can be determined by using the LiDAR detection capability of system 1110, based on a calculation using the return light and the speed-of-light constant.

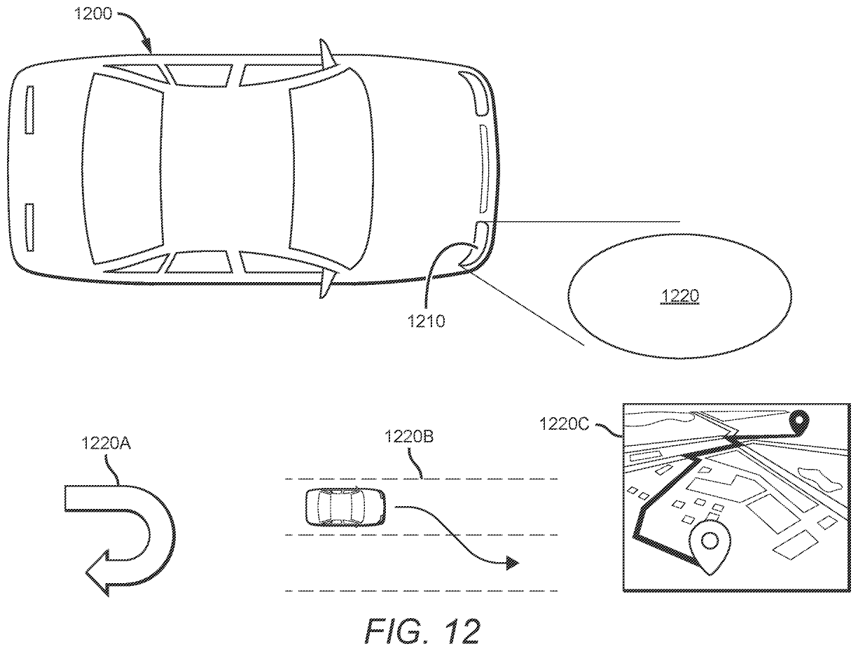

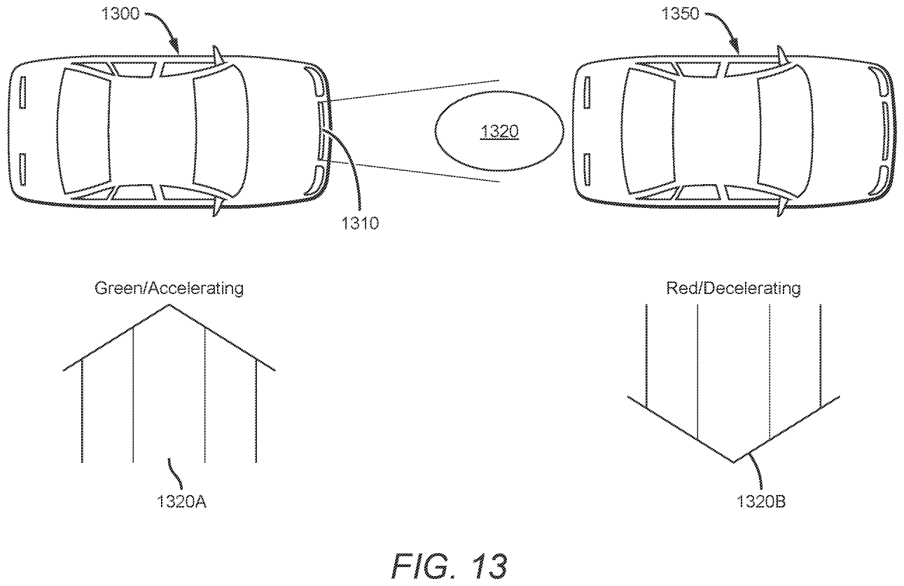

FIG. 12 is a diagram illustrating an example integrated LiDAR and vehicle light system 1210 projecting light patterns to a road surface around a vehicle 1200 having the integrated LiDAR and vehicle light system 1210, according to some embodiments. System 1210 can be any one of systems 700, 800, 800A-800C described above. As shown in FIG. 12, a vehicle 1200 is mounted with multiple integrated LiDAR and vehicle light systems. One such system is shown as system 1210, which is mounted to the vehicle 1200's front right corner. System 1210 can be any one of systems 700, 800, 800A-800C described above. The following disclosure for FIG. 12 uses this system 1210 as an example, but it is understood that the disclosure also can be used for other such integrated systems mounted to another part of vehicle 1200.

Integrated system 1210 can generate transmission light by one or more light sources. The transmission light can include a detection portion and a non-detection portion. Both portions can be transmitted out by, for example, a steering mechanism and/or other optics as described above. In one example, as shown in FIG. 12, the non-detection portion of the transmission light is used to display a light pattern 1220 on a road surface near vehicle 1200. The road surface may be detected by using the return light received by integrated system 1210. Based on the return light, the distance from integrated system 1210 to the road surface can be calculated by integrated system 1210. Therefore, the light pattern 1220 can be projected to display on the road surface at the calculated distance. The light patterns on the road surface near vehicle 1200 can be used for complex navigation signals that are not currently available as the standard vehicle signal lights. For example, the projected light pattern 1220 can be formed to indicate a U-turn light pattern 1220A, a lane changing pattern 1220B, or a light pattern 1220C showing the vehicle 1200's current intended route. Other standard light patterns (e.g., left turn pattern, right turn pattern) or non-standard light patterns can also be projected using the non-detection portion of the transmission light by integrated system 1210. These light patterns can be formed by using one or more of the optical components described above (e.g., light emitting elements arranged in arrays, diffusers, micro-lenses, modulators, etc.) and can help other drivers or vehicles to obtain more information about the vehicle 1200.

FIG. 13 is a diagram illustrating an example integrated LiDAR and vehicle light system 1310 projecting light patterns around a target vehicle, according to some embodiments. System 1310 can be any one of systems 700, 800, 800A-800C described above. As shown in FIG. 13, a vehicle 1300 is mounted with multiple integrated LiDAR and vehicle light systems. One such system is shown as system 1310, which is mounted to the vehicle 1300's front middle part (e.g., above or with the front bumper). System 1310 can be any one of systems 700, 800, 800A-800C described above. The following disclosure for FIG. 13 uses this system 1310 as an example, but it is understood that the disclosure also can be used for other such integrated systems mounted to other part of vehicle 1300.

Integrated system 1310 can generate transmission light by one or more light sources. The transmission light can include a detection portion and a non-detection portion. Both portions can be transmitted out by, for example, a steering mechanism and/or other optics as described above. In one example, as shown in FIG. 13, the non-detection portion of the transmission light is used to display a light pattern 1320 on a road surface near a target vehicle 1350, which is LiDAR detectable by system 1310. The road surface near the target vehicle 1350 may be detected by using return light received by integrated system 1210. Based on the return light, the distance from integrated system 1310 to the road surface can be calculated. Therefore, the light pattern 1320 can be projected to display on the road surface at the calculated distance. The light pattern 1320 on the road surface near target vehicle 1350 can be used for indicating the status of the target vehicle 1350. For example, integrated LiDAR and vehicle light system 1310 has the capability to detect an object based on the return light resulting from the detection portion of the transmission light. Based on the return light, the system 1310 calculates the distance of the object at any time point. With multiple of these distance calculations at different time points, the target vehicle 1350's status can be obtained. Such status includes the movement speed, moving direction, trajectory, acceleration or deceleration, etc. Projected light pattern 1320 can be formed to provide a status indicator of the target object 1350. For instance, as shown in FIG. 13, light pattern 1320 can be a quad up arrow in green color, indicating that target object 1350 is accelerating or moving away from vehicle 1300. Light pattern 1320 may be a quad down arrow in yellow or red color, indicating that target object 1350 is decelerating or stopping. These light patterns thus provide visual indications of the status of other target objects near vehicle 1300. The visual indications can serve as a safety aid for the driver of vehicle 1300, or for a vehicle perception and control system. These light patterns can be formed by using one or more of the optical components described above (e.g., light emitting elements arranged in arrays, diffusers, micro-lenses, modulators, etc.).

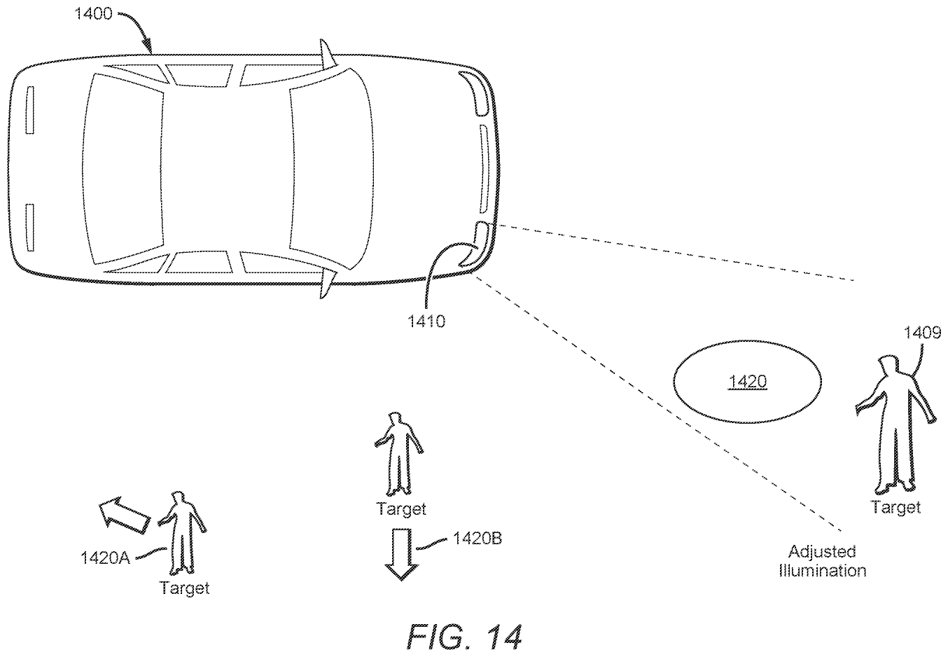

FIG. 14 is a diagram illustrating an example integrated LiDAR and vehicle light system 1410 projecting light patterns around a pedestrian, according to some embodiments. System 1410 can be any one of systems 700, 800, 800A-800C described above. As shown in FIG. 14, a vehicle 1400 is mounted with multiple integrated LiDAR and vehicle light systems. One such system is shown as system 1410, which is mounted to the vehicle 1400's front right part (e.g., at the front right headlight fixture). System 1410 can be any one of systems 700, 800, 800A-800C described above. The following disclosure for FIG. 14 uses this system 1410 as an example, but it is understood that the disclosure also can be used for other such integrated systems mounted to other part of vehicle 1400.

Integrated system 1410 can generate transmission light by one or more light sources. The transmission light can include a detection portion and a non-detection portion. Both portions can be transmitted out by, for example, a steering mechanism and/or other optics as described above. In one example, as shown in FIG. 14, the non-detection portion of the transmission light is used to display a light pattern 1420 on a road surface near a pedestrian 1409 (or a bicyclist, an animal, etc.). The road surface and the pedestrian are both LiDAR detectable. The road surface may be detected by using return light received by integrated system 1410. Based on the return light, the distance from integrated system 1410 to the road surface can be calculated. Therefore, the light pattern 1420 can be projected to display on the road surface at the calculated distance. The light pattern 1420 on the road surface near pedestrian 1409 can be used for indicating the status of the pedestrian 1409. For example, integrated LiDAR and vehicle light system 1410 has the capability to detect an object based on the return light resulting from the detection portion of the transmission light. Based on the return light, the system 1410 calculates the distance of the pedestrian at any time point. With multiple of these distance calculations at different time points, the pedestrian 1410's status can be obtained. Such status includes the movement speed, moving direction, trajectory, acceleration or deceleration, etc. of the pedestrian 1409. Projected light pattern 1420 can be formed to provide a status indicator of the pedestrian 1409. For instance, as shown in FIG. 14, light pattern 1420A can be an arrow in red color, indicating that pedestrian 1409 is likely moving toward vehicle 1400. Light pattern 1420B may be an arrow in green color, indicating that pedestrian 1409 is moving away from vehicle 1400. These light patterns thus provide visual indications of the status of pedestrian 1409 near vehicle 1400. The visual indications can serve as a safety aid for the driver of vehicle 1400, for a vehicle perception and control system. These light patterns can be formed by using one or more of the optical components described above (e.g., light emitting elements arranged in arrays, diffusers, micro-lenses, modulators, etc.).

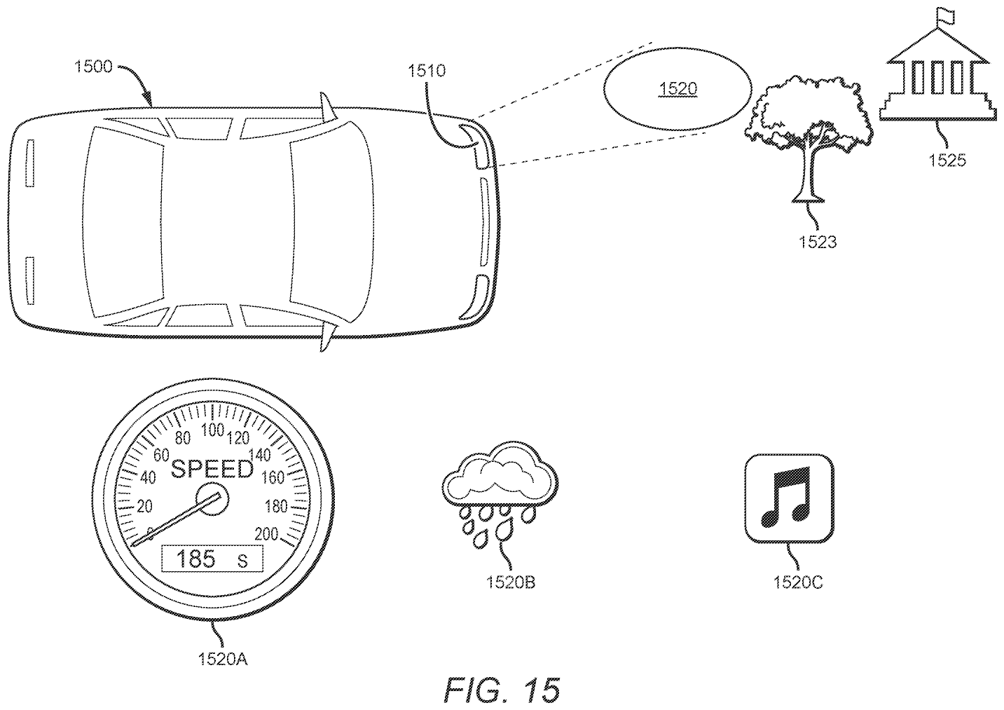

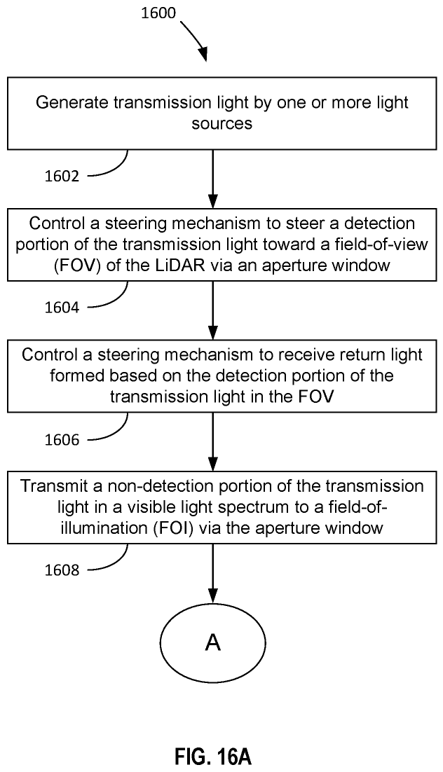

FIG. 15 is a diagram illustrating an example integrated LiDAR and vehicle light system 1510 projecting light patterns 1520 onto an object, according to some embodiments. System 1510 can be any one of systems 700, 800, 800A-800C described above. As shown in FIG. 15, a vehicle 1500 is mounted with multiple integrated LiDAR and vehicle light systems. One such system is shown as system 1510, which is mounted to the vehicle 1500's front left part (e.g., at the front left headlight fixture). System 1510 can be mounted to another part of vehicle 1500. The following disclosure for FIG. 15 uses this system 1510 as an example, but it is understood that the disclosure also can be used for other such integrated systems mounted to other part of vehicle 1500.

Integrated system 1510 can generate transmission light by one or more light sources. The transmission light can include a detection portion and a non-detection portion. Both portions can be transmitted out by, for example, a steering mechanism and/or other optics as described above. In one example, as shown in FIG. 15, the non-detection portion of the transmission light is used to display a light pattern 1520 on a roadside object such as a tree 1523, a building 1525, a fence, etc. These roadside objects are LiDAR detectable by system 1510. The roadside object may be detected by using return light received by integrated system 1510. Based on the return light, the distance from integrated system 1510 to the road surface can be calculated. Therefore, the light pattern 1520 can be projected to display on the roadside object at the calculated distance. The light pattern 1520 projected onto a roadside object can be used for displaying information of vehicle 1500. For example, projected light pattern 1520 can be formed to provide the current vehicle speed, weather, infotainment system information, etc. of vehicle 1500. FIG. 15 shows several examples of light pattern 1520. For instance, system 1510 can project a light pattern 1520A to show a speedometer indicating the current speed of vehicle 1500. System 1510 can also project a light pattern 1520B to show the forecasted weather in the next hour, day, or so. System 1510 can also project a light pattern 1520C to show the infotainment information (e.g., the title/singer of the music being played). These light patterns 1520A-1520C thus provide visual indications of the information associated with vehicle 1500. In some examples, when vehicle 1500 operates at a medium to high speed, the displayed information in pattern 1520 can be generally fixed in the angle of projection, such as approximately 45 degree forward to the left (or to the right) of vehicle 1500 or the driver thereof. The displayed information may be only large enough in the viewing angle so that the driver of vehicle 1500 can see the information, but it would be too small for drivers of other vehicles to see. In some embodiments, the projection of light pattern 1520 by system 1510 can be beneficially toward higher elevations if possible, to avoid projecting directly onto other vehicles and pedestrians around vehicle 1500. These light patterns can be formed by using one or more of the optical components described above (e.g., light emitting elements arranged in arrays, diffusers, micro-lenses, modulators, etc.).

FIGS. 12-15 show various different light patterns displayed for different purposes. Other light patterns can also be displayed for any other purposes to show any desired information. For example, light patterns may be projected by an integrated LiDAR and vehicle light system (e.g., systems 700, 800, 800A-800C, 1110, 1210, 1310, 1410, and 1510) for ornamental purposes, such as to provide lighting effects around the vehicle.

A vehicle (e.g., vehicles 100, 1100, 1200, 1300, 1400, and 1500) may include an integrated LiDAR and vehicle light system (e.g., system 700, 800, 800A-800C, 1110, 1210, 1310, 1410, and 1510) described above, and the integrated system may be controlled by the vehicle to generate visible illumination or visible vehicle signals. The vehicle may further control the integrated system to send the non-detection portion of the transmitted light to other integrated systems or other LiDAR systems not mounted on the vehicle, to communicate data, such as in Vehicle-to-Vehicle (V2V) communications or Vehicle-to-Infrastructure (V2I) communications or Vehicle-to-Everything (V2X) communications.

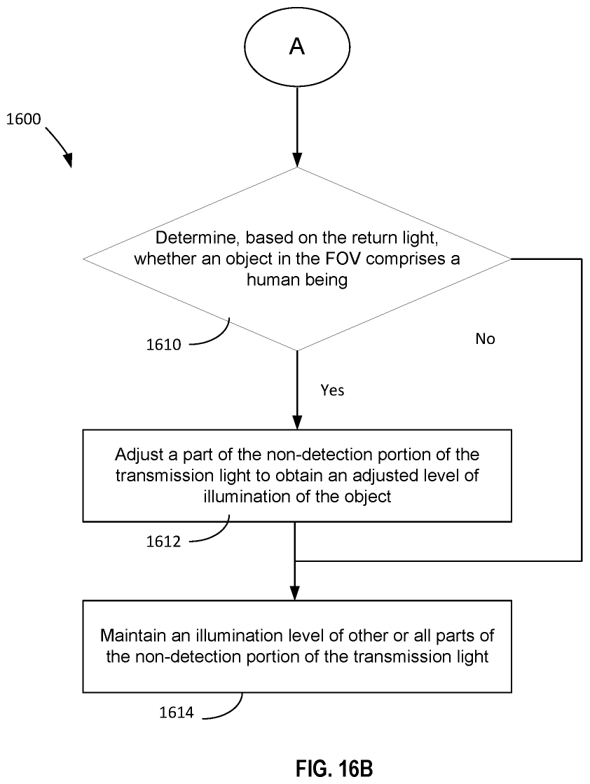

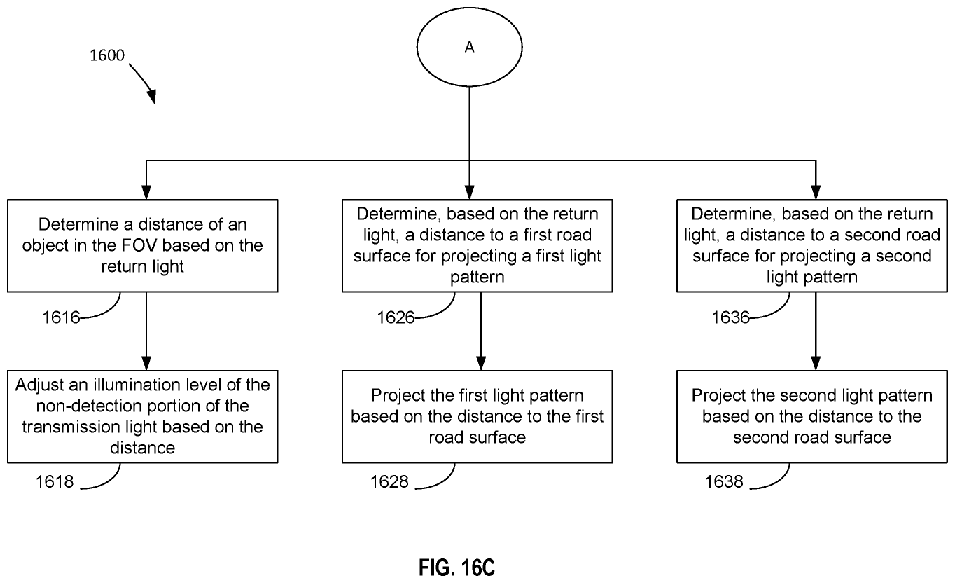

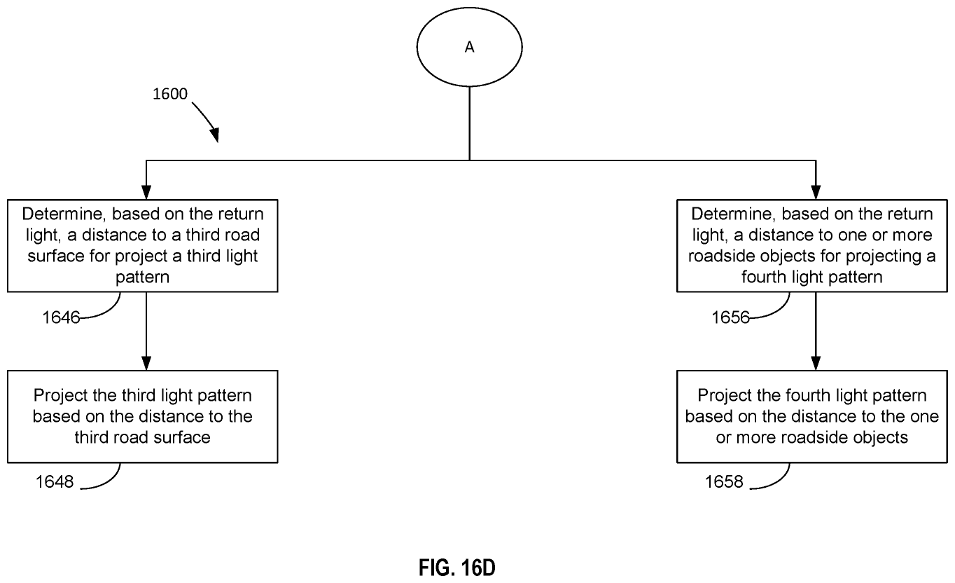

FIGS. 16A-16D is a flowchart illustrating a method 1600 for operating an example integrated LiDAR and vehicle light system, according to some embodiments. The method 1600 can be performed by any of the integrated systems 700, 700A-700B, 800, 800A-800C, 1110, 1210, 1310, 1410, or 1510. With reference to FIG. 16A first, method 1600 may begin with a step 1602, in which one or more light sources (e.g., light sources 710, 810, 810A-810B, 910, 1010) of the integrated system generate transmission light.

In step 1604, a steering mechanism (e.g., steering mechanism 340, 740, 840) of the integrated system is controlled, by control circuitry (e.g., circuitry 350 or 750) to steer a detection portion of the transmission light toward a field-of-view (FOV) of the LiDAR via an aperture window (e.g., aperture window 760, 760A, 760B, 850, 860, 860, 1060).

In step 1606, the steering mechanism is further controlled to receive return light formed based on the detection portion of the transmission light in the FOV. In step 1608, the integrated system transmits a non-detection portion of the transmission light in a visible light spectrum to a field-of-illumination (FOI) via the aperture window.

Continuing to FIG. 16B, in step 1610 of method 1600, the integrated system determines, based on the return light, whether an object in the FOV comprises a human being. In step 1612, in response to determining that the object in the FOV comprises a human being (i.e., “yes” for step 1610), the integrated system adjusts a part of the non-detection portion of the transmission light to obtain an adjusted level of illumination of the object. In step 1614, the integrated system maintains an illumination level of other parts of the non-detection portion of the transmission light. In response to determining that the object in the FOV does not comprise a human being (i.e., “no” for step 1610), the integrated system maintains an illumination level of all parts of the non-detection portion of the transmission light.

With reference to FIG. 16C, each of steps 1616, 1626, and 1636 can follow the step 1608 in FIG. 16A. Thus, each of these steps can be additional or alternative steps to step 1610 in FIG. 16B. In step 1616, the integrated system determines a distance of an object in the FOV based on the return light. In step 1618, the integrated system adjusts an illumination level of the non-detection portion of the transmission light based on the distance.

In step 1626, the integrated system determines, based on the return light, a distance to a first road surface for projecting a first light pattern. In step 1628, the integrated system projects the first light pattern based on the distance to the first road surface, the first light pattern being associated with signaling of the vehicle (e.g., U-turn signals, intended route, lane-changing signals).

In step 1636, the integrated system determines, based on the return light, a distance to a second road surface for projecting a second light pattern. The second road surface is in proximity to a second vehicle different from the vehicle to which the integrated LiDAR and vehicle light system is mounted. In step 1638, the integrated system projects the second light pattern based on the distance to the second road surface, the second light pattern being associated with a moving status of the second vehicle (e.g., accelerating or decelerating).

With reference to FIG. 16D, each of steps 1646 and 1656 can follow step 1608 in FIG. 16A. Thus, each of these steps can be additional or alternative steps to step 1610 in FIG. 16B and steps 1616, 1626, and 1636 in FIG. 16C. In step 1646, the integrated system determines, based on the return light, a distance to a third road surface for projecting a third light pattern, the third road surface being in proximity to a pedestrian. In step 1648, the integrated system projects the third light pattern based on the distance to the third road surface, the third light pattern being associated with a moving status of the pedestrian.

In step 1656, the integrated system determines, based on the return light, a distance to one or more roadside objects for projecting a fourth light pattern. In step 1658, the integrated system projects the fourth light pattern based on the distance to the one or more roadside objects.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A system for light ranging and detection (LiDAR) integrated with vehicle light fixtures, comprising:
one or more light sources configured to generate transmission light;
a window; and
a steering mechanism controlled to:
steer a detection portion of the transmission light toward a field-of-view (FOV) of the LiDAR via the window,
receive return light formed based on the detection portion of the transmission light in the FOV;
wherein a non-detection portion of the transmission light is transmitted in a visible light spectrum to a field-of-illumination (FOI) via the window.

2. The system of claim 1, wherein the one or more light sources are controllable to adjust one or more of brightness, color, direction, focus, or contrast of at least a part of the non-detection portion of the transmission light.

3. The system of claim 1, wherein the one or more light sources comprise one or more red-green-blue (RGB) light emitting diodes (LEDs) capable of changing color, the one or more RGB LEDs being arranged in one or more 1-dimensional or 2-dimensional arrays configured to generate the non-detection portion of the transmission light.

4. The system of claim 1, wherein the detection portion of the transmission light and the non-detection portion of the transmission light are arranged to be non-coaxial.

5. The system of claim 1, wherein the steering mechanism comprises a polygon mirror having a plurality of reflective facets, the polygon mirror being configured to:
receive the non-detection portion of the transmission light at a first reflective facet; and
receive the detection portion of the transmission light at a second reflective facet.

6. The system of claim 5, wherein the first reflective facet and the second reflective facet are different facets.

7. The system of claim 5, wherein the first reflective facet and the second reflective facet are the same facet.

8. The system of claim 1, wherein the one or more light sources comprises:
a first light source configured to generate the non-detection portion of the transmission light; and
a second light source configured to generate the detection portion of the transmission light, the detection portion of the transmission light and the non-detection portion of the transmission light having different wavelengths.

9. The system of claim 1, wherein the window is configured to generate, based on the transmission light, at least one of the non-detection portion of the transmission light and the detection portion of the transmission light.

10. The system of claim 1, further comprising an optical wavelength converter configured to generate, based on the transmission light, at least one of the non-detection portion of the transmission light and the detection portion of the transmission light.

11. The system of claim 1, wherein the non-detection portion of the transmission light is transmitted through the window as vehicle illumination light or vehicle signaling light.

12. The system of claim 1, wherein the steering mechanism is further controlled to steer the non-detection portion of the transmission light toward the FOI via the window, the FOI being different from the FOV.

13. The system of claim 1, wherein a part of the steering mechanism is controlled to steer the detection portion of the transmission light toward the FOV via the window; and a different part of the steering mechanism is controlled to steer the non-detection portion of the transmission light toward the FOI via the window.

14. The system of claim 1, wherein the detection portion of the transmission light is in the non-visible light spectrum.

15. The system of claim 1, wherein the window converts a part of the transmission light in a non-visible light spectrum to form the detection portion of the transmission light in the visible light spectrum transmitting.

16. The system of claim 1, wherein the window comprises one or more of optical diffusers, optical waveguides, and optical retroreflectors.

17. The system of claim 1, further comprising one or more light patterning optics including: an optical diffuser, an optical waveguide, an optical retroreflector, a micro-lens array, and an optical modulator, wherein at least one of the optics is configured to facilitate forming a visible light pattern based on the non-detection portion of the transmission light.

18. The system of claim 17, wherein a combination of one or more of the window, the steering mechanism, and the one or more light patterning optics is configured to form a light pattern using the non-detection portion of the transmission light.

19. The system of claim 1, wherein the non-detection portion of the transmission light forms a light pattern comprising one of more of: a left turn signaling pattern, a right turn signaling pattern, a U-turn signaling pattern, a lane-change signaling pattern, and an intend route.

20. The system of claim 1, wherein the non-detection portion of the transmission light forms a light pattern comprising one or more of: a pattern indicating accelerating of another vehicle and a decelerating pattern of another vehicle.

21. The system of claim 1, wherein the non-detection portion of the transmission light forms a light pattern comprising one or more of: a pattern indicating a moving direction of a pedestrian.

22. The system of claim 1, wherein the non-detection portion of the transmission light forms a light pattern projected onto a roadside object, the light pattern comprising one or more of: a speed of a vehicle to which the system is mounted, weather information, and infotainment information.

23. The system of claim 1, wherein the steering mechanism comprises one or more of a polygon mirror, a planar mirror, a microelectromechanical systems (MEMS) mirror, an optical prism, and an optical lens.

24. The system of claim 1, further comprising control circuitry configured to control the non-detection portion of the transmission light in a non-continuous way.

25. The system of claim 1, wherein the non-detection portion of the transmission light has a temporal profile.

26. The system of claim 1, wherein at least one of the one or more light sources comprises a plurality of light emitting elements, each of the plurality of light emitting elements is controllable independently from other light emitting elements to form a light pattern.

27. A method for operating an integrated light ranging and detection (LiDAR) and vehicle light system, the system being mountable to a vehicle, the method comprising:
generating transmission light by one or more light sources;
controlling a steering mechanism to:
steer a detection portion of the transmission light toward a field-of-view (FOV) of the LiDAR via an window,
receive return light formed based on the detection portion of the transmission light in the FOV; and
transmitting a non-detection portion of the transmission light in a visible light spectrum to a field-of-illumination (FOI) via the window.

28. The method of claim 27, further comprising controlling the one or more light sources to adjust one or more of brightness, color, direction, focus, or contrast of at least a part of the non-detection portion of the transmission light.

29. The method of claim 27, wherein the one or more light sources comprise one or more red-green-blue (RGB) light emitting diodes (LEDs) capable of changing color, the one or more RGB LEDs being arranged in one or more 1-dimensional or 2-dimensional arrays configured to generate the non-detection portion of the transmission light.

30. The method of claim 27, wherein the detection portion of the transmission light and the non-detection portion of the transmission light are arranged to be non-coaxial.

31. The method of claim 27, wherein the steering mechanism comprises a polygon mirror having a plurality of reflective facets, the method further comprising:
receiving the non-detection portion of the transmission light at a first reflective facet of the polygon mirror; and
receiving the detection portion of the transmission light at a second reflective facet of the polygon mirror.

32. The method of claim 31, wherein the first reflective facet and the second reflective facet are different facets.

33. The method of claim 31, wherein the first reflective facet and the second reflective facet are the same facet.

34. The method of claim 27, wherein generating transmission light by one or more light sources comprises:
generating, by a first light source, the non-detection portion of the transmission light; and
generating, by a second light source, the detection portion of the transmission light, the detection portion of the transmission light and the non-detection portion of the transmission light having different wavelengths.

35. The method of claim 27, further comprising generating, by the window or an optical wavelength converter, at least one of the non-detection portion of the transmission light and the detection portion of the transmission light.

36. The method of claim 27, wherein the non-detection portion of the transmission light is transmitted through the window as vehicle illumination light or vehicle signaling light.

37. The method of claim 27, further comprising controlling the steering mechanism to steer the non-detection portion of the transmission light toward the FOI via the window, the FOI being different from the FOV.

38. The method of claim 27, further comprising:
controlling a part of the steering mechanism to steer the detection portion of the transmission light toward the FOV via the window; and
controlling a different part of the steering mechanism to steer the non-detection portion of the transmission light toward the FOI via the window.

39. The method of claim 27, wherein the detection portion of the transmission light is in the non-visible light spectrum.

40. The method of claim 27, further comprising converting a part of the transmission light in a non-visible light spectrum to form the detection portion of the transmission light in the visible light spectrum transmitting.

41. The method of claim 27, further comprising forming a light pattern using the non-detection portion of the transmission light.

42. The method of claim 27, further comprising forming a light pattern comprising one of more of: a left turn signaling pattern, a right turn signaling pattern, a U-turn signaling pattern, a lane-change signaling pattern, and an intend route.

43. The method of claim 27, further comprising forming a light pattern comprising one or more of: a pattern indicating accelerating of another vehicle and a decelerating pattern of another vehicle.

44. The method of claim 27, forming a light pattern comprising one or more of: a pattern indicating a moving direction of a pedestrian.

45. The method of claim 27, forming a light pattern projected onto a roadside object, the light pattern comprising one or more of: a speed of a vehicle to which the system is mounted, weather information, and infotainment information.

46. The method of claim 27, wherein the non-detection portion of the transmission light is controlled in a non-continuous way.

47. The method of claim 27, wherein the non-detection portion of the transmission light has a temporal profile.

48. The method of claim 27, wherein at least one of the one or more light sources comprises a plurality of light emitting elements, further comprising: controlling each of the plurality of light emitting elements independently from other light emitting elements to form a light pattern.

49. A system for light ranging and detection (LiDAR) integrated with vehicle light fixtures, comprising:
one or more light sources configured to generate transmission light, the one or more light sources comprising at least one RGB light emitting diodes (LEDs) capable of changing color, the one or more RGB LEDs being arranged in one or more 1-dimensional or 2-dimensional arrays configured to generate the non-detection portion of the transmission light;
a window; and
a steering mechanism controlled to:
steer a detection portion of the transmission light toward a field-of-view (FOV) of the LiDAR via the window,
receive return light formed based on the detection portion of the transmission light in the FOV;
wherein a non-detection portion of the transmission light is generated by the RGB LEDs and transmitted in a visible light spectrum to a field-of-illumination (FOI) via the window.

50. The system of claim 49, wherein the one or more light sources are controllable to adjust one or more of brightness, color, direction, focus, or contrast of at least a part of the non-detection portion of the transmission light.

51. The system of claim 49, wherein the detection portion of the transmission light and the non-detection portion of the transmission light are arranged to be non-coaxial.

52. The system of claim 49, wherein the steering mechanism comprises a polygon mirror having a plurality of reflective facets, the polygon mirror being configured to:
receive the non-detection portion of the transmission light at a first reflective facet; and
receive the detection portion of the transmission light at a second reflective facet.

53. The system of claim 52, wherein the first reflective facet and the second reflective facet are different facets.

54. The system of claim 52, wherein the first reflective facet and the second reflective facet are the same facet.

55. A method for operating an integrated light ranging and detection (LiDAR) and vehicle light system, the system being mountable to a vehicle, the method comprising:
generating transmission light by one or more light sources comprising one or more 1-dimensional or 2-dimensional arrays;
controlling a steering mechanism to:
steer a detection portion of the transmission light toward a field-of-view (FOV) of the LiDAR via a window,
receive return light formed based on the detection portion of the transmission light in the FOV; and
transmitting a non-detection portion of the transmission light in a visible light spectrum to a field-of-illumination (FOI) via the window.

56. The method of claim 55, further comprising:
determining, based on the return light, whether an object in the FOV comprises a human being;
in response to determining that the object in the FOV comprises a human being,
adjusting a part of the non-detection portion of the transmission light to obtain an adjusted level of illumination of the object, and
maintaining an illumination level of other parts of the non-detection portion of the transmission light.

57. The method of claim 56, wherein the adjusted level of illumination of the object comprises one or more of:
a dimmed illumination;
no illumination;
a blinking illumination; or
a combination of a dimmed illumination and a blinking illumination.

58. The method of claim 55, further comprising:
determining a distance of an object in the FOV based on the return light; and
adjusting an illumination level of the non-detection portion of the transmission light based on the distance.

59. The method of claim 55, further comprising:
determining, based on the return light, a distance to a first road surface for projecting a first light pattern; and
projecting the first light pattern based on the distance to the first road surface, the first light pattern being associated with signaling of the vehicle.

60. The method of claim 55, further comprising:
determining, based on the return light, a distance to a second road surface for projecting a second light pattern, the second road surface being in proximity to a second vehicle different from the vehicle to which the integrated LiDAR and vehicle light system is mounted; and
projecting the second light pattern based on the distance to the second road surface, the second light pattern being associated with a moving status of the second vehicle.

61. The method of claim 55, further comprising:
determining, based on the return light, a distance to a third road surface for projecting a third light pattern, the third road surface being in proximity to a pedestrian; and
projecting the third light pattern based on the distance to the third road surface, the third light pattern being associated with a moving status of the pedestrian.

62. The method of claim 55, further comprising:
determining, based on the return light, a distance to one or more roadside objects for projecting a fourth light pattern; and
projecting the fourth light pattern based on the distance to the one or more roadside objects.

63. A vehicle comprising a system for light ranging and detection (LiDAR) integrated with vehicle light fixtures, comprising:
one or more light sources configured to generate transmission light;
a window; and
a steering mechanism controlled to:
steer a detection portion of the transmission light toward a field-of-view (FOV) of the LiDAR via the window,
receive return light formed based on the detection portion of the transmission light in the FOV;
wherein a non-detection portion of the transmission light is transmitted in a visible light spectrum to a field-of-illumination (FOI) via the window,
wherein the system is controlled by the vehicle to generate visible illumination or visible vehicle signals.
